(19) United States
(12) Patent Application Publication
(10) Pub. No.: US 2005/0135532 A1
(43) Pub. Date: Jun. 23, 2005

(54) Methods and apparatus to induce D-D and D-T reactions

(76) Inventors: Rusi P. Taleyarkhan, Knoxville, TN (US); Colin D. West, Oliver Springs, TN (US)

Correspondence Address: UNITED STATES DEPARTMENT OF ENERGY, 1000 INDEPENDENCE AVENUE, S.W., ATTN: GC-62 (ORO), MS 6F-067, WASHINGTON, DC, 20585-0162, US

(21) Appl. No.: 10/692,755

(22) Filed: Oct. 27, 2003

(51) Int. Cl. G21B 1/00; G21J 1/00

(52) U.S. Cl. 376/100

(57) ABSTRACT

A nuclear fusion reactor including a structure for placing at least a portion of a liquid into a tension state, the tension state being below a cavitation threshold of the liquid. The tension state imparts stored energy into the liquid portion. A cavitation initiation source provides energy to the liquid portion sufficient to nucleate at least one bubble having a bubble radius greater than a critical bubble radius of the liquid. A structure for imploding the bubbles produces imploded cavities. The temperature generated by the implosion process can be sufficient to induce a nuclear fusion reaction involving the liquid. A method of providing nuclear fusion tensions a liquid, cavitates the tensioned to form at least one bubble, then implodes the bubble, wherein a resulting temperature is generated that is sufficient to induce a nuclear fusion reaction involving the liquid.

### FIELD OF THE INVENTION

The invention relates to cavitation, more specifically to methods and apparatus for bubble generation and subsequent implosion for inducing nuclear reactions. The United States Government has rights to this invention pursuant to Contract No. DE-AC05-000R22725 with UT-Battelle, LLC, awarded by the United States Department of Energy.

### BACKGROUND OF THE INVENTION

Nuclear fusion occurs when positively charged nuclei of atoms collide together. Because like-charged particles repel each other, the forces required to overcome these opposing nuclear forces are generally extremely high. Accordingly, nuclear fusion does not occur as a natural process on earth, as there are no known natural forces on earth that overcome this nuclear repulsive force.

However, for bodies with huge masses, such as the earth's sun, the stronger gravitational force created by its huge mass is sufficient to compress atoms upon themselves to initiate nuclear fusion processes. This compression technique is also used in thermonuclear weapons where the force of the atomic (fission) explosion is used to compress the atoms together to initiate the nuclear fusion process.

There are other ways to initiate a nuclear fusion process. In order to increase the chance that atoms collide with one another and cause a nuclear fusion reaction, the atoms can be placed in a highly excited state. One way to put atoms in a highly excited state is to heat them up to a sufficiently high temperature. For nuclear fusion to occur, these temperatures must generally be at least about 10,000,000 K. Such temperatures are achievable under certain conditions.

At sufficiently high temperatures matter can reach the plasma state. Since plasma is an electrically conductive state, this property can be used to achieve the temperatures required to initiate nuclear fusion reactions. Currently, there are four different methods that can be used to achieve temperatures sufficient to initiate nuclear fusion.

A first method is ohmic heating. In ohmic heating, an electrical current is passed through the conductive plasma to heat it. However, ohmic heating is less efficient above about 20-30 million Kelvin and it also requires a pre-heating step to initially put the matter in its plasma state.

Another method is neutral-beam injection. In neutral-beam injection, high energy neutral atoms are introduced into the plasma and are ionized. The energy from the high-energy ions is then transferred to the plasma thereby raising its temperature.

Magnetic compression is another method. In magnetic compression, a strong magnetic field around the electrically charged plasma is used to compress the atoms together. This method can provide two benefits. The temperature inside the reactor is raised by the compression and the density of atoms is increased thereby increasing the chance of collisions.

Finally, radio frequency heating is a further possible method. In radio-frequency heating, high-frequency waves are directed towards the matter. The electromagnetic energy from these waves is then absorbed by the matter resulting in heating of the matter.

Since the fuel used for nuclear fusion reactors must be initially heated sufficiently to cause the collisions among the atoms, tremendous amounts of energy must be supplied to the system. Additional energy may be necessary, such as to maintain powerful magnetic fields or other energy sources. When compared to the amount of energy that can be produced by available fusion reactors, the energy input into the reactor is substantially greater than the amount of energy produced by the reactor. Accordingly, nuclear fusion reactors have yet to become a viable source of energy.

### SUMMARY OF THE INVENTION

The invention uses pretensioning to impart energy into a working liquid, cavitates the tensioned liquid to generate at least one bubble, and then implodes the bubble. Energy released upon bubble implosion can produce heating sufficient to induce nuclear fusion reactions.

It has been known for some time, although not widely recognized, that liquids, like solids, can be put under negative pressure. A condition of negative pressure is generally referred to as a state of tension, the tension state being a condition opposite to a state of compression.

However, liquids cannot be tensioned beyond a certain tension limit. Upon reaching a critical tension state, liquids fracture through the process of cavitation and release a portion of stored potential energy associated with the previous tension state upon the transition from liquid to the vapor phase.

Cavitation can be defined as the formation, growth, and collapse of vapor bubbles in a liquid. Cavitation can be forced to occur in a variety of ways, such as by ultrasonic/acoustic waves, lasers or by hydrodynamics. Cavitation is a well-known phenomenon which occurs when the pressure of a liquid is lowered to the point where a liquid starts to boil into a vapor, the local pressure being lower than the vapor pressure of the liquid.

A cavitation based system according to the invention can be configured to initiate nuclear fusion reactions. The system includes structure for placing at least a portion of a working liquid into a tension state. The tension state is below a cavitation threshold of the liquid and imparts stored potential energy into the liquid portion. A cavitation initiation source provides sufficient energy to nucleate at least one bubble having a bubble radius greater than a critical bubble radius of the liquid used. Upon implosive collapse of the bubble, initiated and driven by increasing the pressure in the liquid to put it in compression instead of tension, the external pressure does work on the bubble, compressing it and raising its internal temperature. The temperature of the imploded cavity can be sufficient to induce a nuclear fusion reaction involving some of the molecules in the bubble or cavity.

The structure for tensioning can include a controller for controlling the tension level in the liquid. Structure for generating an oscillatory pressure field can be provided in the liquid, where a compressive phase of the pressure field implodes at least one bubble formed.

During the implosive collapse process, emission of tritium and penetrating radiation including neutrons has been found to be time correlated and substantially coincident with the sonoluminescence (SL) light flash that occurs. In addition, simulations of the experimental conditions described herein indicate that simulated bubble implosion temperatures attained from experimental conditions are sufficient to induce nuclear fusion reactions which, once initiated, can form fusion related products such as neutrons and tritium.

A nuclear fusion reactor includes a reactor chamber for holding a working liquid and structure for placing at least a portion of the liquid into a tension state. The tension state is below a cavitation threshold of the liquid. The tension state imparts stored energy into the liquid portion. A cavitation initiation source is adapted for nucleation of at least one bubble from the tensioned liquid, the bubble having a bubble radius greater than a critical bubble radius of the liquid. The reactor also includes structure for imploding the bubble, wherein following implosion of the bubble, a resulting temperature sufficient to induce at least one nuclear fusion reaction is provided. The reactor can include a vacuum pump for degassing the liquid, or the liquid can be provided a priori in a degassed state.

The structure for placing the liquid under tension can be an acoustical wave source, which preferably includes an acoustical wave focusing device. The structure for placing the liquid under tension can include at least one centrifugal source, magnetostrictive source, or piezoelectric source.

The cavitation initiation source can include an acoustical source, fundamental particle sources, such as alpha emitters, neutron sources and fission fragment sources, or a laser source. When an alpha emitter or a fission source is used, they can be dissolved in the liquid.

The cavitation initiation source is preferably a neutron source. The neutron source can be an isotopic source having at least one shutter, where the shutter is opened to synchronize neutron impact with a location in the liquid when the liquid is in that location at a predetermined tension level.

The working liquid preferably includes an enriched deuterium or tritium containing liquid. For example, deuterated acetone may be used.

The reactor can include a controller for synchronizing delivery of at least one cavitation initiation signal from the cavitation initiation source at a predetermined location in the liquid. The reactor can include structure for cooling the liquid to a temperature below an ambient temperature.

The reactor can generate tritium and/or and neutrons. Accordingly, the reactor can be used as a neutron source or for the production of tritium. Tritium has wide ranging applications, such as use in nuclear hydrogen bombs, lighting lights or dials of watches, or as an energy source for batteries. When used as a neutron source, the invention can be embodied as a portable neutron source. Such a source can be used for explosives detection, food/materials irradiation, or radiography.

The reactor can include at least one external constraint for restraining the working liquid. This embodiment can be adapted to launch projectiles.

Under correct parameters, the invention may be used to configure a power plant, such as an electricity generating plant. A nuclear fusion-based electrical power plant includes a reactor chamber for holding a working liquid and structure for placing at least a portion of the liquid into a tension state. The tension state is below a cavitation threshold of the liquid, the tension state imparting stored energy into the liquid portion. A cavitation initiation source is included for nucleation of at least one bubble from the tensioned liquid, the bubble having a bubble radius greater than a critical bubble radius of the liquid. The power plant includes structure for imploding the bubble, wherein following implosion of the bubble a resulting temperature sufficient to induce at least one nuclear fusion reaction is provided to the liquid. The plant also includes structure for converting energy released from the fusion reaction to electrical energy.

The invention can be used to configure a projectile launcher. In this embodiment, the bubble fusion system includes a movable constraint bounding the reaction chamber for transferring energy from the fusion reaction to propel a projectile.

A method for producing nuclear fusion includes the steps of placing a liquid into a tension state, the tension state being below the cavitation threshold of the liquid. The tension state imparts stored energy into the liquid. At least a portion of the tensioned liquid is cavitated to nucleate at least one bubble, the bubble having a bubble radius greater than a critical bubble radius of the liquid. The bubble is then imploded, wherein a resulting temperature from the implosion is sufficient to induce a nuclear fusion reaction involving the liquid or its vapor. The fusion reaction can be a D-D reaction or a D-T reaction. The method preferably includes the step of degassing the liquid or cooling the liquid to a temperature below an ambient temperature.

### BRIEF DESCRIPTION OF THE DRAWINGS

A fuller understanding of the present invention and the features and benefits thereof will be accomplished upon review of the following detailed description together with the accompanying drawings, in which:

FIG. 1 is a schematic illustration of an apparatus, including an acoustic reaction chamber which was used to demonstrate fusion induced in deuterated acetone.

FIG. 2(a) are design details of the acoustic reaction chamber shown in FIG. 1.

FIG. 2(b) are alternate design details for an acoustic reaction chamber which can be used for producing fusion reactions.

FIGS. 3(a)-(f) illustrates a time sequence of events related to bubble generation, bubble growth and bubble implosion.

FIG. 4 is a schematic illustration of a fusion-based system which can provide self sustained power generation.

FIG. 5(a) is a schematic illustration of a conical fusion reaction chamber design.

FIG. 5(b) is a schematic illustration of a spherical fusion reaction chamber design.

FIG. 5(c) is a schematic illustration of a cylindrical fusion reaction chamber design.

FIG. 5(d) is a schematic illustration of a pulsed mode reaction chamber where cavitation bubbles are produced via burst acoustic pulses focused in fluid regions nucleated.

FIG. 5(e) is a schematic illustration of a venturii-based system for inducing bubble nucleation showing subsequent bubble collapse downstream to induce nuclear fusion reactions.

FIG. 6(a) illustrates an exemplary centrifugal-based reaction chamber configuration.

FIG. 6(b) illustrates bubble dynamics and the stages of a cavitation bubble including bubble nucleation, bubble growth, and bubble implosion using centrifugal-based reaction chamber shown in FIG. 6(a).

FIG. 7 is a schematic illustration of alternate chamber design for nucleating and collapsing cavities which utilizes explosive bursts.

FIG. 8(a) is a schematic illustration of a fusion powered electrical generator.

FIG. 8(b) is a schematic illustration of a fuel assembly including neutron blankets which can be used to power the electric generator shown in FIG. 8(a).

FIG. 9 is a schematic illustration of an explosive burst generator configured as a projectile launcher.

FIG. 10 illustrates T activity changes for C₃D₆O and C₃H₆O with neutron irradiation as compared to neutron irradiation plus tensioning.

FIG. 11 illustrates changes in measured neutron counts for C₃D₆O and C₃H₆O with and without cavitation.

FIG. 12 illustrates a data trace for cavitation tests with C₃D₆O at 0° C. showing coincidence between the SL flash and the scintillator pulse, and the subsequent microphone response about 30 μs later.

FIG. 13 illustrates SL and neutron coincidence data for C₃D₆O and C₃H₆O.

FIG. 14(a) illustrates coincidence data for C₃D₆O.

FIG. 14(b) illustrates coincidence data for C₃H₆O.

FIG. 15 illustrates time spectrum data for C₃D₆O and C₃H₆O.

FIG. 16 illustrates predicted variation of implosion gas temperatures as a function of the temperature and phase-change coefficient of the working liquid.

### DETAILED DESCRIPTION OF THE PREFERRED EMBODIMENTS

The invention includes methods and apparatus for inducing nuclear fusion reactions. A suitable liquid is first placed into a metastable state, such as a tension state. For example, in the case of liquid tensioning, a tension state is reached which is below a cavitation threshold for the particular liquid. The liquid can be substantially pure or can be a mixture of liquids. A tension state imparts stored energy into a portion of a liquid, or can impart energy into the entire liquid volume. Liquid tensile states are one example of a metastable state as defined below.

In the case of tensioning, after the metastable state is reached, at least one initiation signal from a cavitation initiation source is directed to the metastable liquid portion. The initiation signal provides sufficient energy to cavitate the tensioned liquid through bubble nucleation of at least one bubble having a bubble radius greater than a critical bubble radius (r_{crit}) for the specific liquid used.

The critical bubble radius (r_{crit)} is a function of the pressure within the bubble (P_{bubble}), the ambient pressure (P_{ambient}) and the surface tension of the liquid ( ), and is given by the following equation:
r_{crit}=2/(P_{bubble}−P_{ambient})

The formation of at least one bubble having a radius of at least the critical radius (r_{crit}) given above permits the bubble to grow and permits subsequent release of at least a portion of the energy stored by the metastable working liquid. The amount of resulting energy produced is related to the stored energy in the working liquid (e.g., pre-tension level) combined with the energy supplied by the cavitation initiation source and the work done on the bubble during its growth by the structure for providing tensile stress.

Bubble growth can then be arrested, such as with a compressive pressure field. As a result, the bubble can collapse to form an imploded cavity. Implosive bubble collapse can generate localized shock waves and be accompanied by extremely high temperatures and pressures. Localized regions of high pressure and temperature can be sufficient to induce nuclear reactions, such as deuterium-deuterium (D-D) reactions or deuterium-tritium (D-T) reactions. Nuclear reactions emit fundamental particles, such as neutrons and gamma rays, which can be utilized for a variety of purposes including neutron generators, power plants and projectile launchers.

A classical system is considered to be in a metastable state if it is in a state above its minimum energy state, but requires an energy input before it can reach a lower energy state. For example, a superheated liquid, such as pure water at 110° C. at one atmosphere pressure, is in a metastable state since its lower energy state is a vapor state. A metastable system can act as a pseudo-stable system, provided that energy inputs, such as from thermal or mechanical sources supplied to the system, remain below some activation threshold. Systems with strong metastability are commonly described as being stable systems. An associated, broader definition of metastable embraces all systems that have a long lifetime by some standard (e.g., a minimum time) in an energy state above its minimum energy state.

A metastable state can be defined to be a fluid state where homogeneous self-nucleation of bubbles due to statistical fluctuations can grow uncontrollably at the limit of homogeneous nucleation. The time involved for such an effect is generally on the order of nanoseconds. Therefore, metastable states not at the limit of self-nucleation from statistical fluctuations generally involve time frames that are orders of magnitude longer than the nanosecond range. Upon application of suitable cavitation initiation source energy to the metastable liquid, such as from neutrons, alpha particles or laser beam heating, the growth to critical bubble radii can be in the nanosecond range.

During implosive bubble collapse, sonoluminescence can occur. Sonoluminescence (SL) is the generation of extremely short (about 10⁻¹¹ to 10⁻⁹ s) light flashes during implosive collapse of gas/vapor bubbles. During single-bubble sonoluminescence (SBSL), for example, a single gas bubble can be trapped in the acoustic field of a liquid-filled chamber operating in a resonant mode at the velocity antinode. With the proper acoustic pressure amplitude, a single bubble can persist at high frequencies (e.g., 27 kHz) for several hours, emitting an extremely brief (e.g., 10² ps or less) and regular SL flash during each cycle of the applied sound wave.

Previous work has suggested that temperatures greater than 10⁴ K and perhaps as high as 10⁶ K, along with SL emission mechanisms other than blackbody radiation, can be produced from bubble implosion. However, to induce nuclear fusion reactions requires even higher temperatures, such as at least about 10⁷ K.

The invention produces temperatures sufficient to induce nuclear fusion reactions using cavitation based systems. Increasing the maximum radius Rₘ of the bubble before implosion results in a large increase in the work done by the compressive forces that are collapsing the bubble, and therefore, in the peak temperature of the imploded gas. For example, it has been found that a 50% increase in Rₘ can result in an increase of about 400% in SL emission intensity. Since the stored mechanical energy is proportional to the volume change of the bubble and the volume change is proportional to the bubble radius change raised to the third power, a 50% increase in bubble radius results in about a 350% increase in mechanical energy buildup prior to bubble implosion.

The attainable increase in bubble radius can be large. For example, the maximum bubble radius, Rₘ, can be related to the initial bubble radius Rₒ, where Rₒ is the initial bubble radius as formed from the cavitation initiation process. The ratio of Rₘ/Rₒ can be about 10⁵ or more. This is about 4 orders of magnitude greater than obtained in other previously proposed experiments for cavitation induced fusion.

The SL intensity can also be increased by increasing the rate of collapse of the imploding bubble. The rate of bubble collapse can be made more abrupt through more intense shock generation as compared to previous approaches and by a reduction in the amount of gas dissolved gas in the working liquid, which can otherwise result in gas cushioning.

High phase-change coefficient liquids are preferably used as working fluids since they produce more intense states of compression and temperature buildup as compared to low phase-change coefficient liquids. High phase-change coefficient liquids provide a phase-change coefficient which approaches the maximum possible value of 1. Such liquids permit rapid evaporation of liquid during bubble growth and more importantly, also provide rapid condensation during the implosion phase. Organic liquids generally also allow attainment of large tension states without propensity for premature cavitation, and as such permit buildup of significant storage of superheat in the metastable state. This superheat can then be used to grow larger bubbles relative to their initial states than would otherwise be possible with liquids such as water, which has a phase-change coefficient of about 0.07.

One method for attaining large Rₘ/Rₒ ratios (e.g., in the 10⁵ range) is based on nucleating cavities using nuclear particles, such as neutrons or alpha recoils, in pre-tensioned degassed deuterated liquids. Under these conditions, nucleation of critical size bubbles takes place in the 10-100 nm range, which can than be grown to the 1 mm range.

To minimize the effect of gas cushioning during implosive collapse, the working liquid can be degassed, a priori. Alternatively or in combination, a sufficient vacuum state above the working liquid accompanied by induction of gaseous cavitation induced by nuclear particles such as neutrons or via use of lasers or acoustic horns can be used to reduce the dissolved gas content in the working liquid to limit unwanted gas cushioning.

Several other well-established methods can be used for this purpose. For example, gas pockets can be removed from, or dissolved in, the working liquid by boiling it or subjecting it to high compressions (e.g. 1 kbar) for a minimum time of about 15 minutes after which dispersed gases in the form of micro-bubbles go into solution.

Following degassing of the working liquid, the liquid is tensioned and nucleation of vapor cavities followed by implosion of the same can be initiated. Tensioning the liquid can be provided by a variety of methods, including an acoustical wave source, an electrostrictive (piezoelectric) source, a magnetostrictive source, a centrifugal source, a focused (pulsed) acoustic energy or a venturii based system. Preferably, when an acoustical wave source is used, the acoustical wave source includes an acoustical focusing device, such as a parabolic-type reflector or a resonant cavity to intensify the acoustic pressure.

The cavitation initiation source can be any suitable source for nucleating at least one bubble from the tensioned liquid. Cavitation initiation sources can include an acoustical wave source, or a source of fundamental particles, such as alpha emitters, neutron sources and fission fragment sources. When an acoustical wave source is used for tensioning, the same acoustical wave source (or one or more additional acoustical sources) can be used for cavitating the liquid. Alternatively, the cavitation initiation source can be a laser. As a further alternative, the structure for cavitating can be a radioactive source dissolved in the working liquid.

If an acoustic pressure field is used for tensioning the liquid and a neutron source is used for cavitating the liquid, the neutron source is preferably equipped with structure to provide neutrons at a desired time. For example, an isotopic source (e.g., Pu—Be) equipped with a shutter or a pulsed neutron generator (PNG) that can produce neutrons on demand at a predefined phase of the acoustic pressure field can be used. For a spherical bubble cavity, an increase of Rₘ/Rₒ by a factor of 10⁴ implies a related volumetric ratio increase (and therefore, stored energy) of 10¹² (trillion fold) since volume is proportional to r³. Such a volumetric ratio increase can, as has been demonstrated, vastly (e.g., trillion fold) increase energy concentration potential during implosion and result in a significant increase in the final temperatures provided by the imploding cavities.

To produce D-D or D-T reactions, it is preferred that the working liquid includes deuterium (D) or tritium (T) atoms, D and T being isotopes of hydrogen. Other atoms with higher binding energies may be used, but they generally require far stronger implosion dynamics. Also, hydrogen atom bearing liquids, although theoretically possible to fuse, are not preferred due to the very long containment times generally necessary.

Organic liquids provide an advantage in that they permit attainment of high levels of tension without premature cavitation. This permits significant superheat to build up prior to nucleation and the ability to nucleate bubbles from fast neutrons with modest negative pressures (e.g. −7 bar). The relatively large phase-change (accommodation) coefficients generally provided by organic liquids, such as acetone and ethanol, also permits rapid shock buildup during collapse.

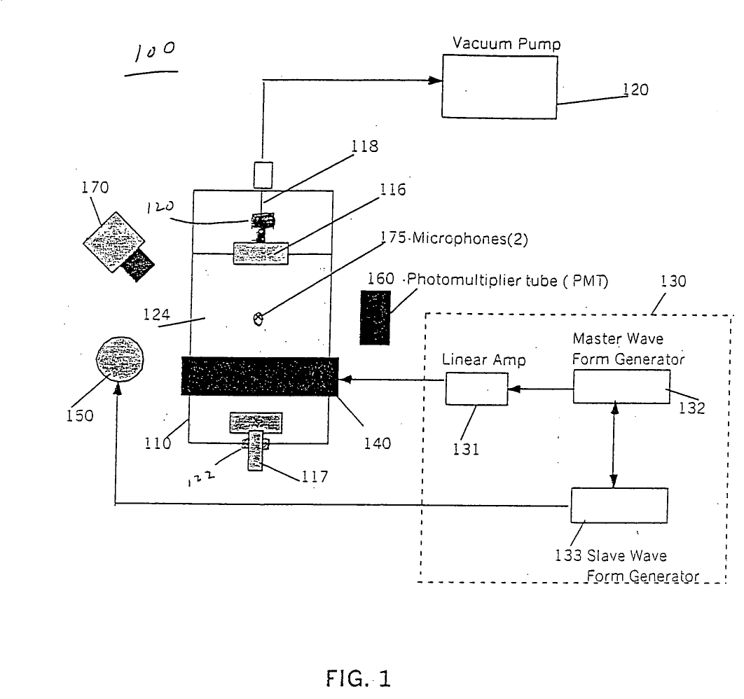

FIG. 1 is a schematic illustration of the cavitation based fusion reactor system 100 which was used to generate and detect products associated with cavitation induced nuclear fusion. System 100 includes components to detect emitted neutrons, SL flashes, and shock waves associated with bubble generation, bubble growth and bubble implosion.

System 100 includes reaction chamber 110. The reaction chamber 110 is filled with a suitable working fluid 124, such as deuterated acetone, but not generally fully. The fluid in chamber 110 is shown shaded. Chamber 110 is an acoustic chamber, and includes upper piston 116 and lower piston 117, which together define a resonant cavity. Pistons are preferably hollow glass. Upper piston 116 floats on working liquid 124 and as a result, sits only partially in working liquid 124.

Top piston 116, if less dense than the working fluid, is anchored with wires to the top opening of chamber 110. Such flexible anchoring permits free motion of the top piston 116 during acoustic agitation and minimizes stresses causing breakage (as would happen if the top piston 116 were welded to the top of chamber 110). The top piston 116 (if hollow) is preferably covered with porous material 120 which permits pressure equalization and prevents working fluid spray drops from entering and filling up the top piston 116.

Pistons 116 and 117 are preferably anchored to chamber 110. Pistons 116 and 118 can be flexibly anchored to chamber 110, through use of wire anchors 118, while piston 117 can be rigidly anchored to chamber 110 through use of a suitable sealant 122.

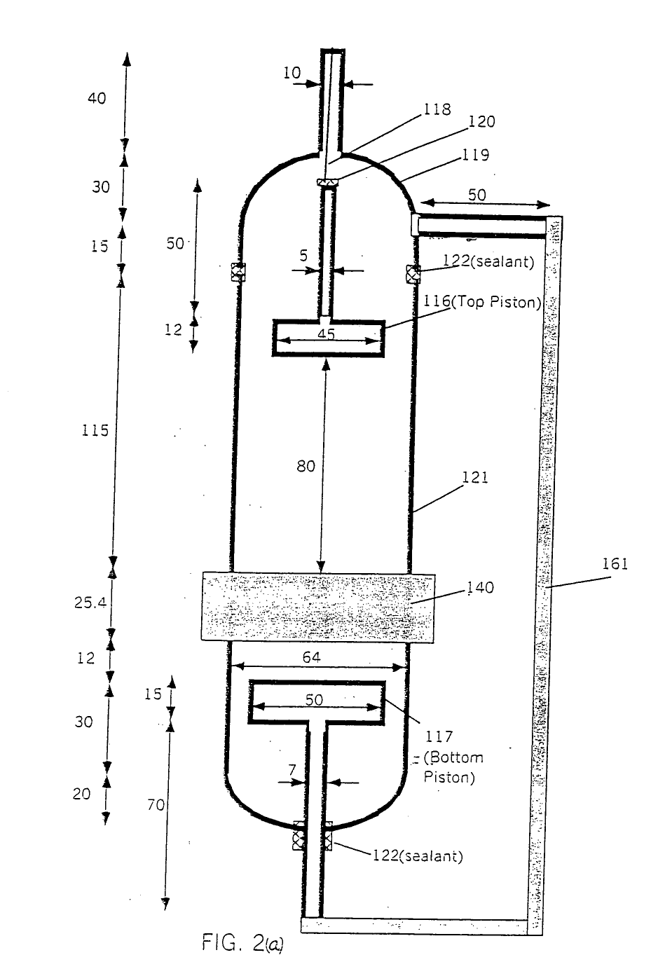

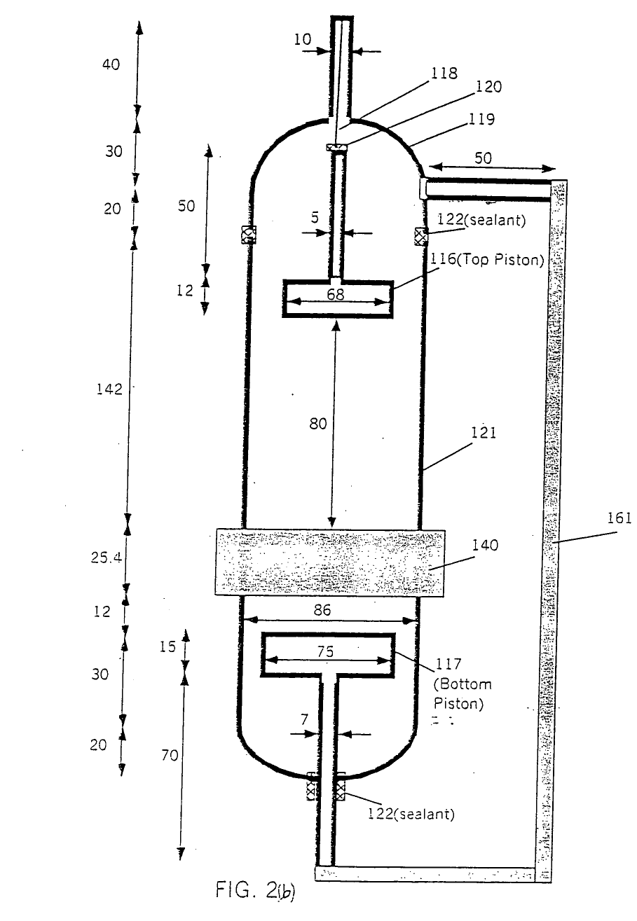

A vacuum pump 120 evacuates the chamber volume above the working liquid 115. A minimum preferred vacuum state is approximately the vapor pressure of the liquid at the operating temperature. A vacuum of 27 inches of mercury was used for the experiments performed with deuterated acetone at about 0° C. As shown in FIG. 2(a), chamber 110 provides a fluid connection 161 between the bottom of chamber 110 and the top of chamber 110 to equalize pressure between the same.

A wave form generator 130 comprising linear amplifier 131, master wave form generator 132 and slave waveform generator 133 is coupled to a PZT ring 140 for generating tunable acoustic waves for pretensioning the working fluid. A pulse neutron generator (PNG) 150 was provided as the cavitation initiation source. The phase angle between the drive to the PZT 140 and the PNG 150 is preferably selected to correspond to the threshold for cavitation onset. Such a phase relationship permits the bubble to grow for a longer period of time and hence to larger sizes.

A photo multiplier tube (PMT) 160 is provided for detecting light emissions. A plastic scintillator 170 is provided for detecting neutron emissions, while microphones 175 are provided for detecting sound (shock) waves resulting from bubble implosion.

In the experiments performed the head of plastic scintillator 170 was positioned 10 cm from PNG 150 and 3 cm from chamber 110. The PMT 160 was positioned 5 cm from chamber 110. System 100 is preferably positioned at least 1.5 m above a suitable floor, such as a concrete floor. These distances are only exemplary and, as with the examples provided, are in no way are intended to limit the scope of the invention.

Although not shown, a refrigeration device is preferably provided for maintaining the reaction chamber 110 at a sub-ambient temperature. In some of the experiments performed, a temperature of about 0° C. was used. A lower working fluid temperature generally results in improved system performance since vapor condensation during implosion becomes increasingly more rapid leading to stronger shocks, which results in compression and temperature intensification.

The PZT 140 is attached to the glass chamber 110. Attachment improves coupling. Electrode connections are made to the inside surface of the driver 140. It is recommended that several such connections be made to ensure the system 100 does not need to be disabled for repair if one of the connections gets broken. Attachment of the PZT 140 to the wall of chamber 110 should be done carefully. Any suitable adhesive can be used. However, an ordinary epoxy compound, such as that used for joining materials, (e.g., typical 30 minute two-part epoxy compound) mixed with a suitable coupling agent in the form of small (micro scale) beads, is preferred. Beads can be micron size glass or ceramic beads.

Coupling agents added to the epoxy mixture enable optimal transfer of mechanical energy from PZT 140 to the walls of chamber 110 and permit good and gradual transfer of mechanical transport properties. For glass chamber walls a mixture of glass beads in epoxy compound in a ratio of about 1:2 by mass has been found to provide good transfer of mechanical energy from the driver 140 to the reaction chamber walls 110.

To enable flexibility, it is preferred for components of chamber 110 to be pieced together using a suitable compound that is chemically resistant to attack by the working liquid 124. For working liquids such as acetone, tetrachloroethylene, and water, it was found that automotive gasket sealant paste, Permetex® blue RTV silicone gasket maker; product AZUL RTV 6B, available from Great Plains Aircraft Supply Co., Inc., Boys Town, Nebr., provided the best form of protection from attack by organic solvents like acetone and provided good attachment strength (sufficient to hold up under vacuum conditions) for various components of chamber 110 which are described further in FIGS. 2(a) and 2(b).

FIG. 2(a) provides actual dimensions for the chamber 110 components and experimental settings that were successfully utilized for achieving fusion. While FIG. 2(b) provides alternate design details for an acoustic reaction chamber which can also be used for providing fusion reactions. All chamber materials used were made from PyrexTM™ glass. Numbers below 100, shown in FIGS. 2(a) and 2(b), represent actual dimensions in mm which may not be drawn to scale. The glass thickness of the chamber 110 was 2 mm and the pistons 116 and 117 were 1 mm.

Although the reaction chamber 110 can be made in one single piece (i.e., all components of glass welded together), such a design results in significant disruption if any one component is broken or displaced. Forming a reaction chamber 110 having at least two parts 119, and 121 such as with chamber portion 119, comprising the curved crown portion at the top of chamber 110, is preferred to enable dismantling and ensuring cleaning of surfaces of the inside of chamber 110. As shown in FIGS. 2(a) and 2(b), chamber portion 119 can be attached to the hollow straight cylinder with the curved base 121 using sealant 122.

The bottom piston 117 is also preferably attached to the chamber portion 121 such that the stem of bottom piston 117 extends through an opening in chamber portion 121. Sealant 122 can be applied to the joint between stem of bottom piston 117 and opening of chamber portion 121.

The stem of bottom piston 117 is preferably connected to the top chamber portion 119 using fluid connector 161. Fluid connector 161 can be any non-collapsible tubing, such as standard rubber tubing or hollow glass tubing, to equalize pressures between the hollow bottom piston 117 and the top rchamber portion 119. Any fluid connector 161 used should be capable of withstanding vacuum conditions without collapsing.

For the chamber design used, good resonance acoustics were obtained by setting the height of the working liquid above the top of PZT driver 140 by about 80 mm. When using resonant reaction chambers, this distance should be carefully selected. The chamber 110 was found to be capable of inducing +/−15 to 20 bar pressure fluctuations in acetone.

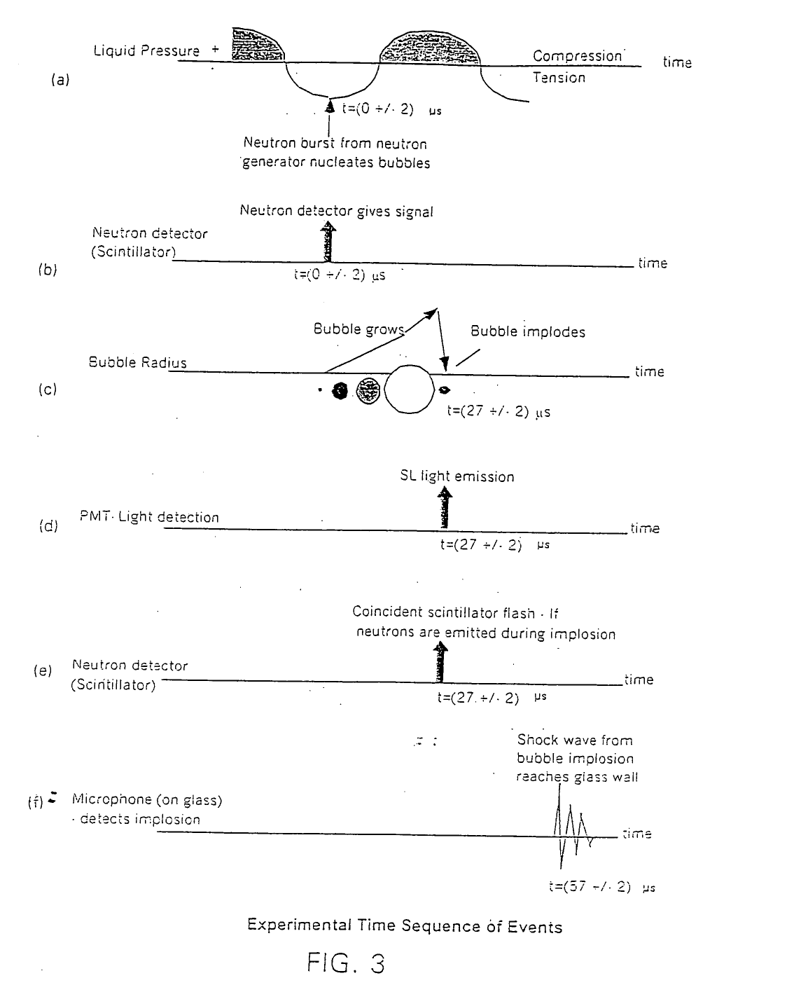

The sequence of events resulting from operation of a cavitation based fusion system, such as system 100, is depicted in FIGS. 3(a)-(f). FIG. 3(a) shows the pressure wave form applied to the working fluid along with a neutron burst synchronized with the maximum tension level in the working liquid. The neutrons applied to the liquid portion under tension nucleate vapor cavities in the tensioned liquid, where the cavitation threshold is exceeded by the energy provided by the neutrons.

Burst neutrons are preferably provided by a pulse neutron generator (PNG). As shown in FIG. 3(b), the neutron detector detects a pulse from the PNG within about 2 μsec after the PNG is fired. Thereafter, as shown in FIG. 3(c), the vapor cavity grows until the surface tension and increasing pressure in the liquid during the second half (compression) of the acoustic cycle cause it to collapse, at about the 27 μsec point into the process.

If the implosion is robust enough, the collapsed bubble interior gets hot enough to emit a SL light flash, which can escape the chamber volume and be detected by a PMT, as shown in FIG. 3(d). Almost simultaneously, if the working liquid includes deuterium (D) and/or tritium (T) atoms and the conditions are appropriate for D-D and/or D-T interactions, nuclear particles such as neutrons, and gamma rays may be emitted and intercepted by a nuclear emission detector.

For example, a D-D fusion reaction can have one of two outcomes, which typically occur with close to equal probability. The first leads to the production of helium (He) and a neutron, the second to the production of tritium (T) and a proton:
D+D→³He+n+3.3 MeV
D+D→T+p+4 MeV

FIG. 3(e) shows detection of a scintillator flash coincident with the detection of SL light, evidencing neutrons are emitted during implosion. Finally, FIG. 3(f) shows the resulting pressure wave from the implosive collapse that travels at about the speed of sound in the test liquid which is detected at the chamber walls by the microphones, for example, 57 μsec following initiation of the process.

The sequence of events shown in FIGS. 3(a)-(f) applies when a single bubble is generated. When multiple bubbles are present, the situation can become more complex with considerable wave energy scattering that can make the microphone signals noisy and difficult to interpret. A few bubbles nucleated at the same time in the same tensioned region, however, will generally grow and collapse as if each were alone, at least during the first few cycles of the sound field.

It has been found that system performance can be influenced by the following parameters, listed in no particular order of importance:
(1) choice of fluid and/or combination of fluids,
(2) operating temperature and degassing state of fluid,
(3) drive (tensioning) system, choice of mode of excitation and induced pressures,
(4) size and location of tensioned region,
(5) number and type of nucleating agents,
(6) chamber type,
(7) control of pressure wave forms (e.g. periodic or aperiodic), and
(8) special/miscellaneous techniques.

In general, the ideal fluid should possess a high phase-change coefficient to permit a high rate of evaporation and condensation, low vapor pressure and high surface tension. In addition, a modest (<10 bar) cavitation threshold for cavitation initiation from fast neutrons or from dissolved emitters such as uranyl nitrate (UN) is also preferred. Cavitation threshold is defined herein as the negative pressure beyond which cavitation will take place.

The ideal fluid should provide low viscosity which enables minimal dissipation of wave energy, such as acoustic wave energy. The ideal fluid should also be safe to handle. Availability with a significant concentration of D and/or T atoms is also highly desirable. “Enriched” fluids may be commercially obtained having levels of deuterated or tritiated species well above naturally occurring isotopic levels of these species.

Several readily available liquids can provide some or all of these characteristics, such as water, C₂Cl₄, acetone, methanol, ethanol. Some of the thermodynamic properties of these liquids are presented in Table 1 below. Organic fluids in general have high phase-change coefficients (close to 1) and low solidification temperatures. For example, acetone freezes at about 178 K versus 273 K for water at standard conditions.

TABLE 1
Properties of Selected Liquids

| Property | | Acetone | C₂Cl₄ | Water |
|---|---|---|---|---|
| Vapor Pressure (kPa) | | | | |
| T = | 273 K | 9 | 0.6 | |
| | = 293 K | 34 | 3 | 4 |
| | −223 K | 0.33 | <0.1 | |

| | | | |
|---|---|---|---|
| Surface tension (mN/m) at 300 K | 23 | 31 | 73 |
| Viscosity (cp) at 300 K | 0.3 | 0.8 | 1 |
| Cavitation threshold (bar) | 7-8 | 6 | >10 |
| for fast neutrons | | | |
| Thermal conductivity | 0.2 | 0.1 | 0.6 |
| (W/m-k) at 300 K | | | |

Liquids, such as C₂Cl₄ and acetone, are preferred liquids because they have low-enough thresholds for cavitation from fast neutrons and more importantly, for inducing high compressions from rapid condensation during implosion since the phase-change coefficient for such liquids is typically close to 1.0, versus only about 0.07 for water. C₂Cl₄ has low vapor pressure and high-enough surface tension, along with a relatively modest threshold for nucleation. But the absence of D and T atoms generally limits its potential for inducing nuclear fusion if used alone. Nevertheless, since C₂Cl₄ is miscible with other liquids such as acetone, it becomes a candidate for bubble implosion to induce D-D or D-T reactions in conjunction with suitable deuterated or tritiated liquids.

Experiments have been performed with mixtures of C₂Cl₄ and acetone to ensure that the mixtures are amenable to cavitation onset from fast neutrons. Experiments have also be performed with acetone-water mixtures and found that these can be cavitated similar to D-acetone by itself, albeit with approximately 25% higher drive amplitudes.

Suitable liquids for D-D or D-T based reactions are not limited to D-acetone or T-acetone or mixtures containing these species. This permits combining model liquids such as C₂Cl₄ or acetone with readily available T-bearing liquids such as tritiated water, thereby, avoiding the need for developing new processes for procuring specific tritiated organic liquids.

Deuterated organic liquids may be tritiated by themselves via irradiation in high (e.g., 10¹⁵ n/cm²-s) thermal flux environments. Other chemistry-based tritiation schemes may also be employed. However, all factors being equal, the use of combined deuterated-cum-tritiated liquids is preferred as compared to use of deuterated liquids alone, due to several known advantages. Such combinations can provide 2-3 orders of magnitude greater fusion cross-sections. In addition, these combinations permit a greater energy fraction to be carried away by neutrons.

The tritium production rate, the neutron production rate and the number of coincidences between SL flashes and the detection of penetrating radiation (an indicator of D-D reaction occurrence) was found to be strongly dependent on temperature of the working liquid. For example, reactions were vastly greater in intensity at about 0° C. as compared to about 20° C. where they virtually disappeared for D-acetone. This permits significantly enhancing system performance by refrigerating the working liquid, such as to temperatures below 0° C. for D-acetone. Since more than about 85% of the energy released during D-D or D-T reactions is generally carried out by neutrons which escape from the liquid region, it is not important that the liquid temperature be high to allow heat energy to be convected out of the system via a heat exchanger as in a conventional nuclear reactor.

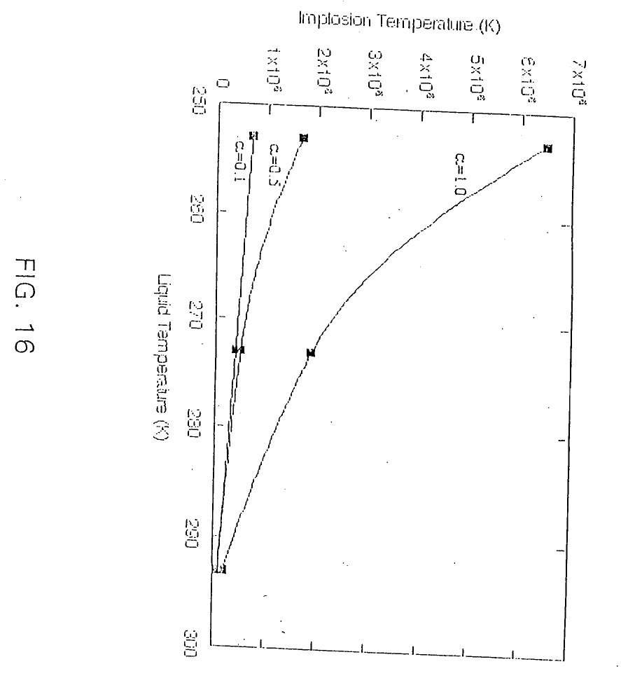

It was found that the fusion reaction dependence on liquid temperature is generally exponential in nature. This is likely because there is generally close to an exponential dependence of vapor pressure on liquid temperature. This can be seen from the data presented in Table 1. FIG. 16 also shows shock code calculations which evidence the sharp dependence of implosion temperature on the temperature of the working liquid.

For an experiment which produced about 4×10⁵ n/s at 0° C., this value was reduced to about 10¹ n/s at 10° C. Therefore, every 10° C. reduction in temperature is expected to result in at least a factor of 10⁴ increase in neutron output. For N-acetone, liquid working temperature could be reduced by about another 100° C., although the cavitation threshold would increase as a result which would have to be compensated by increasing the drive pressure. Even reducing the temperature by 50° C. conservatively might increase neutron output by a factor of about 10⁴ or more.

It is also noted from Table 1 that the vapor pressure for acetone drops from 34 kPa (at 293 K) to about 9.2 kPa (at 273 K). This about 3 fold reduction in vapor pressure caused close to a 10⁵ increase in the neutron production rate. However, the acetone vapor pressure drops from 9.2 kPa at 273 K to around 0.33 kPa at 223 K. Thus, a 50K temperature drop results in 30 times lower vapor pressure. These data show that very significant increases in neutron production should be attainable by reducing the operating temperatures beyond those used in actual experiments performed.

Since only a small fraction of the D and/or T atoms are involved in an implosion, the capacity to vastly improve the neutron output during collapse by modest (e.g., 50 to 100 K) temperature reductions appears to be a useful method for increasing system output. However, system output cannot be expected to increase with decreasing working liquid temperature without limit. At some point decreasing the vapor content of collapsing bubbles could result in reduced system output if there becomes an insufficient number of D and T atoms to fuse.

Degassing the working liquid can also improve system output. The degassing state, which refers to the dissolved gas content of the liquid fuel being used, can also be an important parameter. Gas cushioning, which becomes increasingly important as the liquid temperature gets higher, reduces or can even prevent shock generation and extreme temperature escalation. For the experiments performed the vacuum state employed was a modest 27′ Hg. However, this was sufficient to permit production of an estimated 4×10⁵ n/s. It appears possible that the introduction of a lower gas content-state should enable further improvements in neutron production.

Experiments performed were all conducted at an estimated tensioning drive pressure amplitude of about +/−15 to 20 bar and resulted in a neutron output of an estimated about 4×10⁵ n/s. Increasing the drive pressure amplitude increases the expansion of the vapor cavities, which increases the surface area and permits more vapor to get into the bubble, and also provides more intensified shock generation during the subsequent implosion process. Calculations indicate an approximately ten-fold increase in neutron output for about every 13 bar increase in drive pressure. Sample results of calculations are presented below:

TABLE 2
Relative variation of predicted neutron output
with tensioning drive pressure

| Drive pressure (bar) | Relative neutron output (relative to 15 bar) |
|---|---|
| 15 | 1 |
| 25 | 10 |
| 40 | 60+ |

Therefore, increasing the drive pressure amplitude from 15 bar to about 100 bar could by itself increase the neutron output by a factor of about 10⁴ to 10⁶. One hundred (100) bar is a value that could be readily attained with improved coupling of electronic components or via use of a centrifugal type tensioning apparatus. This assumes that the other conditions remain substantially the same and no spurious cavitation takes place prior to nucleation from the neutron or other nucleating agent source.

Another significant parameter related to tensioning involves the mode of forcing. The experiments performed used a simple sinusoidal variation of the acoustical pressure. However, a more sophisticated forcing scheme, such as the use of one or more additional higher frequencies, can significantly also increase the implosion kinetics. For example, a very high-frequency pressure component of about 200 kHz can be superimposed on a fundamental carrier frequency of 20 kHz. The high frequency component does not significantly contribute to the growth phase. However, during the very rapid implosion phase, the high-frequency pressure component can intensify the collapse phase dynamics if it is timed to coincide with the time when the bubbles are collapsing.

It is not known how much of an increase in neutron output will be attained as a result of using multiple tensioning frequencies. However, the use of multiple tensioning frequencies and variants thereof are expected to increasing the rate of bubble collapse and represent another method for enhancing system output performance.

Another alternative method is to use a plurality of transducers to produce, for example, nearly steady negative pressure during the bubble nucleation and growth phase, followed by a nearly steady positive pressure to drive the collapse. The relative heights and durations of the two halves of this square wave-type drive could be optimized by simulations and/or by experiments. Such waveforms could be produced by computer controlled transducers, for example by using the technique of time reversed acoustics.

The nucleation and growth of vapor cavities takes place in the central region of the chamber shown in FIG. 1 due to the shape of the acoustic field imposed. In general, the larger the “sensitive” zone where high compressive-tensile pressures are available, the greater is the propensity for nucleation, growth and implosion-induced D-D or D-T reactions to take place. Increasing the linear size of the sensitive zone by a factor of 2 would tend to increase the number of cavities formed for a given source strength by a factor of 8. It is generally necessary that the location of this sensitive zone be away from solid surfaces that may become eroded during cavitation and may also lead to diffused energetics.

A wave shaping system can be employed wherein the timing and shape of the acoustic field is set for maximum efficiency, such as maximizing the number of imploding cavities. This will involve appropriately positioning the drivers spatially to derive the desired region of space that maximizes the volume available for bubbles to be nucleated. For example, using 2 PZT drivers and operating them in either parallel or serial mode can provide two or more sensitive zones, rather than one. Using a larger diameter chamber would also permit a larger sensitive zone, and in addition, a lower frequency of oscillation to permit larger growth of the bubbles.

As mentioned earlier, an increase in the bubble size can play an important role in energy buildup. For example, a factor of 2 increase in the size of bubbles can increase the amount of stored energy by a factor of about 10 since the volume change is proportional to the third power of the radius change. To change the bubble size by a factor of 2 by reducing the frequency of operation by a factor of 2 would imply that the size of the reaction chamber would need to double in size.

The timing of the pressure pulses can also be a significant parameter. For induction of optimal spatio-temporal pressure profiles, a preferred method is based on adapting the principles and approaches of time-reversed-mirror (TRM) acoustics. In this approach, by setting a desired pressure field distribution, several small PZT drivers are employed with reverse-engineered driving logic to produce at any given location the desired spatio-temporal pressure field. Such a scheme has been used for other applications, such as to create a shock wave at a given location using time varying input to multiple small drivers. Other more conventional approaches based on fluid-structural dynamic simulations would also generally be suitable for use with the invention.

A variety of cavitation initiation sources can be used with the invention. A preferred cavitation source is a source of fast neutrons. Fast neutrons are neutrons having energies of at least several MeV, preferably having energies in the 14 MeV range. For example, a pulsed neutron generator (PNG) capable of generating up to 10⁸ n/s or a Plutonium-Beryllium (Pu—Be) isotope source emanating about 106 n/s can be used. The use of a PNG is generally preferred, since it can be programmed to deliver bursts of neutrons precisely at the appropriate phase angle of the sound field. The isotope source is preferred for cost and portability.

Another method for cavity nucleation is through use of dissolved emitter of high dE/dx particles. Using uranyl nitrate (UN) up to about 5 weight % dissolved in water allows self-nucleation of bubbles to proceed without the need for any external neutrons. Uranium or a similar emitter dissolved in the chosen liquid such as acetone should be possible to use, as dissolved polonium and thorium have been reported to nucleate bubbles. The principal advantage of such a method would be the long-lasting source activity and no need to provide an external cavitation initiation source.

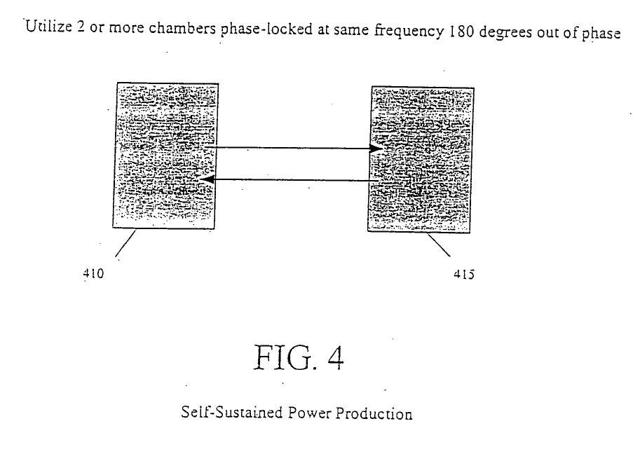

A different methodology for efficiently inducing cavitation which is particularly suited for use in a reactor could use the principle depicted schematically in FIG. 4. Herein, two adjacent fuel assemblies 410 and 415 could operate 180 degrees out of phase (acoustically). The system can be started via use of an external neutron source (not shown) similar to existing light water reactors (LWRs) where a neutron “startup” source is used to start the fission reaction process. Thereafter, the resulting nuclear emissions of neutrons from D-D or D-T reactions in one fuel assembly, such as 410, could be used to nucleate cavities in a neighboring fuel assembly 415.

The use of nuclear particles, such as neutrons for cavity nucleation is currently preferred since nuclear particles permit uniform multi-bubble nucleation on the nm scale, forming bubble nuclei that can then grow in a stable fashion by factors of about 10⁵, or more, prior to imploding. Also, this method permits the generation of either single or multiple cavities by simply increasing the neutron output of the source to the desired level.

However, a reactor can be also be based on other cavitation initiation sources, such as from focused laser beam(s) or microwave energy sources, as long as appropriately nm-scale (10-100 nm) sized bubble nuclei are formed such that the resulting Rₘ/Rₒ ratio and the vapor content buildup can be maintained substantially equivalent to that attainable from nuclear particles, or at least sufficiently large to induce significant D-D or D-T reactions. The use of a focused laser beam or microwave source should be set such that a long vaporous streak and/or cylindrical cavity is not formed as the laser beam passes through the tensioned liquid, which can result from these methods since they use directed energy thermal beams.

An acoustically-resonant reaction chamber is preferably a thin-walled transparent cylindrical cavity with wave reflecting surfaces at the base and at the top. This geometry is preferred because it tends to provide a large sensitive volume for nucleation without spurious cavitation on the walls, and can increase the achieved repetition frequency by encouraging the rapid dissolution of bubbles formed earlier.

Cylindrical volumes in their fundamental mode of operation will typically provide a sinusoidal variation of the acoustic field in the axial direction and a first order Bessel function shape in the radial direction.

However, other chamber shapes and configurations can also be used. For example, a spherical chamber could be used to minimize the volume of the reaction chamber and to provide symmetry, either with or without a necked (narrowed down) surface. If a necked surface is employed, the height of the liquid in the neck should be adjusted to provide optimal performance. The surface waves could be controlled via use of a float of reflecting surface for reflecting back pressure waves, preferably being similar in material composition to the balance of the chamber. A conical flask with a relatively massive (rigid) top could also be employed. The rigid top aids in establishing a pressure node.

An external static pressure may also be preferably employed using an immiscible driver liquid of higher density after degassing with or without a diaphragm seal in between. The imposition of a static overpressure can be useful since it can assist in furthering the collapse of bubbles during the implosion phase.

Pyrex™ glass containers were used for the reaction chamber in the experiments performed. However, other container materials can be used with the invention. For example, quartz may be used. Pyrex™ and other glasses provides good wetting properties, as well as optical and fast neutron transparency.

Some materials may also be used as needed for applications that do not require optical or nuclear transparency. For example, rigid steel chambers may be used with glass coatings on the inside to help ensure good wetting for certain applications. Good wetting with the working fluid can prevent spurious cavitation taking place at the solid-liquid interface which can otherwise disable the resonance characteristics.

Wetting enhancing agents that do not interfere with the working liquid may also be used. However, good wetting is generally only important for systems relying on resonant acoustics. For example, for a pulsed acoustic system where one or more acoustic lenses are radially positioned, the acoustic energy is delivered to result in a compressive-tensile wave combination in the focus region directly without the need for resonant buildup of energy. Thus, for such systems, wetting of the working liquid at the chamber boundaries is not an issue.

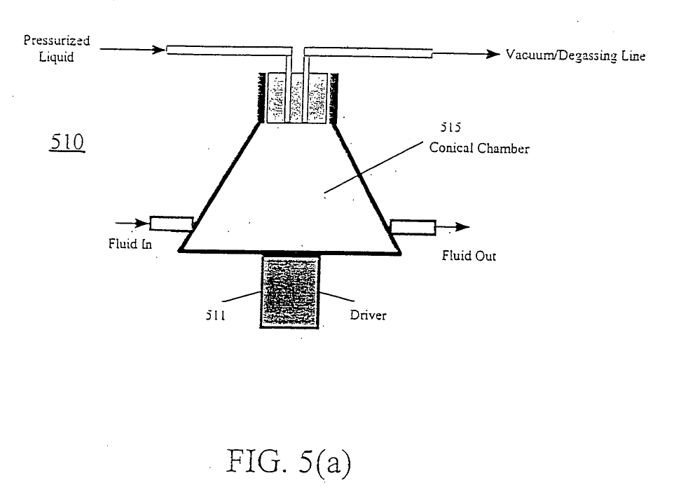

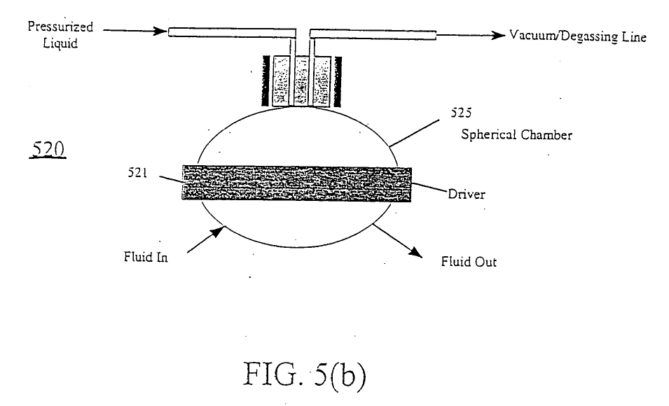

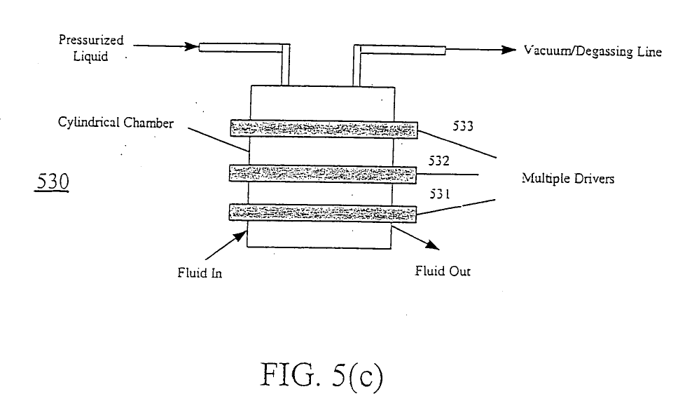

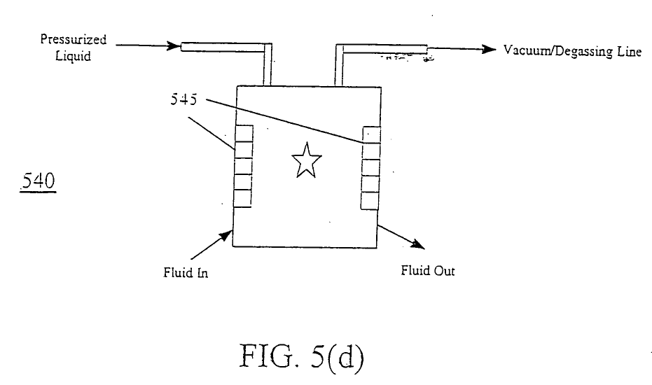

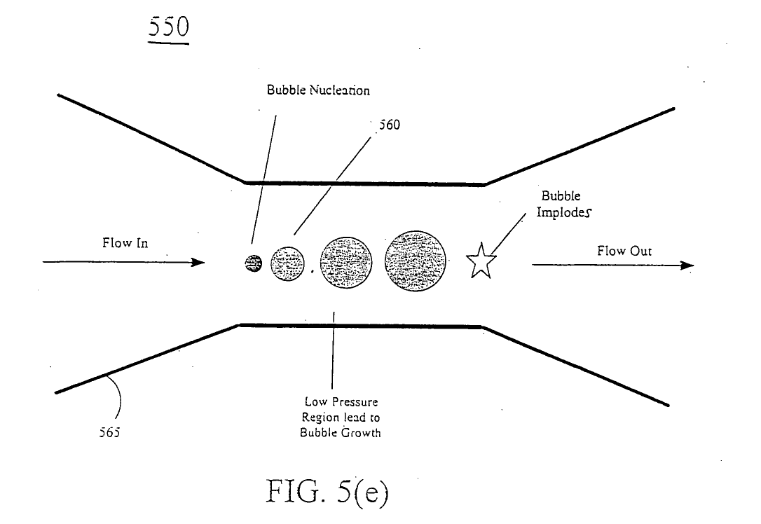

FIG. 5(a)-(e) presents reactors utilizing several alternative reaction chamber configurations. FIG. 5(a) illustrates reactor 510 including a conical reaction chamber 515 along with driver 511. The necked region of such a system is maintained to be rigid to ensure a pressure node there. The pressurized liquid is intended to provide the degree of static overpressure as necessary for enhancing the implosion phase of bubble collapse as discussed earlier. The acoustic driver 511 can be either a piezoelectric or magnetrostrictive element that is excited externally with an amplifier coupled with a wave-form generator.

If sufficient external cooling can be provided, such as by flowing cool air or some other refrigerant, then the liquid need not necessarily flow in a loop. Thus, the liquid can remain isolated in the reaction chamber. Otherwise, a flowing system is beneficial to help convect away heat as needed. A flowing system may also be used to limit buildup of dirt and other impurities in the reaction chamber that can lead to premature cavitation.

FIG. 5(b) illustrates reactor 520 including a spherical reaction chamber 525 along with driver 521. FIG. 5(c) illustrates reactor 530 including a cylindrical reaction chamber 535 with a plurality of pretensioning drivers 531-533 disposed thereon. The various elements of the systems shown in FIGS. 5(b) and (c) are analogous in function to that of the conical shape reaction chamber shown in FIG. 5(a).

FIG. 5(d) illustrates reactor 540 including at least one pulsed acoustic energy delivery system 548 to tension desired regions in fluid space where a cavitation bubble is to be nucleated using a suitable cavitation initiation source. Acoustic energy delivery system 548 includes acoustical source (not shown) and acoustical lenses 545 which focus compressive-tensile pressure waves in sensitive locations where cavitation bubbles are nucleated. Thus, acoustic energy delivery system 548 in reactor 540 provides tension to the working liquid and provides compressional wave to implode bubbles therein.

FIG. 5(e) illustrates reactor 550 which is based on the venturii principle where flowing liquid through the narrow throat 560 of a venturii tube 565 creates a pressure reduction. The pressure reduction depends on the area ratios of the main flow to that of the throat region. The flow velocity can be controlled to deliver the appropriate level of pressure reduction such that bubble nucleation can take place using a suitable cavitation initiation source. In reactor 550, bubbles grow and get carried away by the fluid downstream where they implode as they enter an increased pressure (wider) flow region to produce D-D or D-T reactions.

For a given system, control of the extent and rate of D-D or D-T reactions can be obtained though the control of several parameters. For a system including an acoustical wave based tensioning (drive) source, these parameters include:
(a) working liquid thermal-hydraulics, such as temperature, purity, gas content, flow rate,
(b) cavitation initiation source strength,
(c) drive pressure amplitude,
(d) drive frequency,
(e) the shape of the driving acoustic pressure wave,
(f) varying the liquid level dynamically to control the acoustics,
(g) external constraints, and
(h) use of neutron absorbers/poisons

Varying the liquid thermal-hydraulic parameters such as temperature and flow rate can be effectively used to control the reaction rates of D-D or D-T reactions since the implosion dynamic parameters, such as final temperatures, confinement times and densities, are strongly dependent on initial liquid temperature. These parameters can be used to prevent run-away reactions and provide self-shutdown mechanisms.

The purity and gas content of the working fluid can play an important role since the extent to which a given liquid can be pretensioned prior to premature cavitation induction will generally depend on these factors. As already noted, gas content of the working fluid can also be a significant parameter affecting shock buildup and intensification.

Varying the nucleation source strength (either external or dissolved emitting) for each implosion cycle can either permit the generation of D-D or D-T reactions or completely avoid them. The tensioning drive pressure amplitude can be also used to control the reaction rate by several orders of magnitude as noted earlier.

Varying the drive frequency can, for a high-Q resonant system, significantly change the acoustic resonance characteristics and prevent cavitation from occurring substantially independent of the external source strength or drive pressure amplitude. For continuous operation and to account for drift in resonance frequency with time and temperature, this parameter can be used in a simple close-loop control system configuration using appropriate combinations of inductances, resistances and capacitors or integrated circuitry coupled with the attached microphones sensing system resonance, so as to maintain the system in resonance.

Varying the shape of the driving pressure wave including its mean value can be used to control the time available for bubble growth, and therefore its maximum size, while maximizing the PdV work provided during the collapse phase.

External constraints can be used to create explosive bursts from radiation (e.g., neutrons) produced by the induced fusion process. For example, a system having dimensions so that most of the fast neutrons emanating from D-D or D-T reactions escape the system without significant absorption can direct the neutrons into a blanket region which can be used to capture these neutrons, and as a result, build up heat/pressure.

Suitable blanket materials include materials such as lithium. Lithium can produce tritium from interactions with neutrons. Tritium can then be used as fuel. Fluids, such as water or liquid metals can also be used as blanket materials.

Nominally, the heat and pressure buildup at blanket regions are avoided via heat exchange. However, if a heat exchange is not utilized and a pressure buildup constraint, pressure vessel with a rupture disk or a pre-set pressure relief valve, is not provided for the blanket coolant, explosive pressure loads can be generated for propulsion or generation of shock waves.

Control could also be attained via positioning and use of neutron poisons or control rods similar to that used in present-day light water moderated reactors (LWRs). The use of neutron absorbers or shields could be useful where inter-fuel assembly reaction rates are desired to be controlled to a set level to provide an appropriate level of power output.

Although many of the systems actually configured utilized high frequency PZT drivers, a variety of alternative drive apparatus may also be used. Alternative drivers include centrifugal devices, which are relatively simple devices that can provide the same or similar results as compared to PZT drivers.

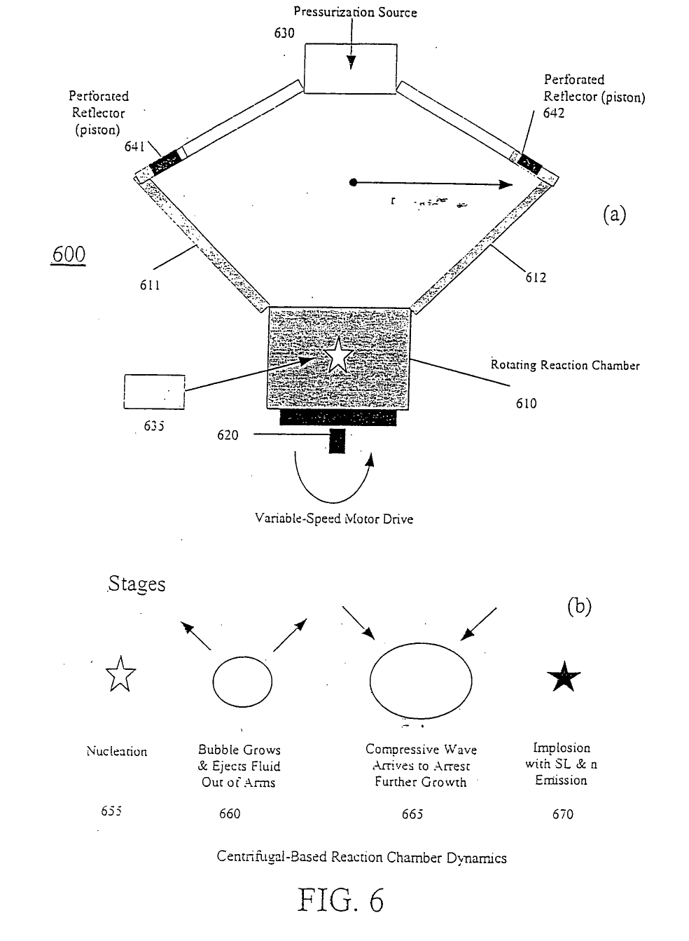

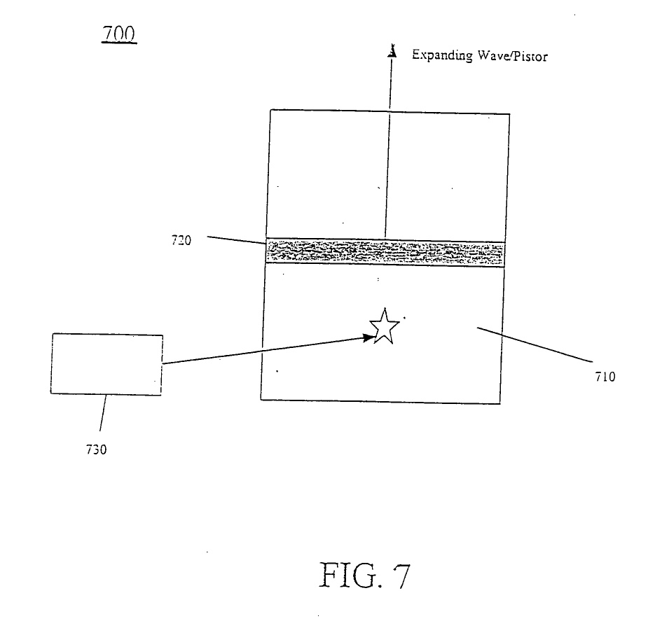

FIG. 6(a) shows fusion system 600 comprising rotatable reaction chamber 610 having connecting arms 611 and 612. The rotatable reaction chamber 610 is propelled by variable speed motor drive 620. The chamber 610 and arms 611 and 612 are filled with the working fluid which is tensioned by rotation. During operation of system 600, the working fluid turns around the bend of the arms at the edge. Such a system is self-stabilizing.

Cavitation initiation source 635 can initiate the formation of single or multiple bubbles and although shown external, can be an external or internal source. A preferred external source is a neutron source, such as a PNG or isotopic source. Cavitation initiation source 635 can also be a laser or a microwave source. Possible internal sources include alpha particle sources dissolved in the working fluid.

The chamber 610 is rotated at set speeds resulting in the fluid in the chamber being subjected to desired levels of tensioning. The degree of negative pressure induced in the working fluid varies directly with the fluid density multiplied by the square of the separation distance “r”, as shown in FIG. 6(a), multiplied by the square of the rotational frequency. The pressure in the rotating arms 611 and 612 varies from being at ambient pressure at the far side of the arm to the most negative at the interface with the central bulb. The pressure variation is described by the following equation:
p_{neg}=19.73×(fluid density)×(arm length)²×(angular rotation speed in Hz)²−ambient pressure

FIG. 6(b) shows various stages in bubble growth using a centrifugal based fusion system. Once the desired level of negative pressure and cavitation energy (e.g. neutrons) is provided sufficient to cause nucleation, single or multiple bubble cavities can be nucleated as depicted by a symbol identified with reference 655. As the bubble grows, fluid is ejected out from the arms, such as 611 and 612 in FIG. 6(a) as shown by a drawing identified with reference 660. Unlike use of a PZT driver where the fluid pressures oscillate at high frequency, the growth of the bubble cavities in the centrifugal device is generally only controlled by the surroundings it is contained in, its surface tension forces and the arrival of compressive pressure waves due to reflection from regions surrounding the growing cavities.

A compressive wave can then be provided to arrest further bubble growth and collapse the bubble shown by a drawing identified with reference 665. Generally, if a compressive wave is not present the expanding cavity, liquid will be forced out of the central chamber of the centrifugal device through the arms and out of the system. Thereafter, the system may need to be refilled prior to commencement of operation. The compressive wave implodes the bubble and produces SL and neutron emission shown by a symbol identified with reference 670, the neutron emission requiring a cavity temperature sufficient to induce nuclear fusion.

However, with a suitable restoring force for producing a compressive wave front a centrifugal arrangement such as shown in FIG. 6(a) could be set up to provide for continuously-pulsed operation. In continuous-pulsed operation, bubble nucleation proceeds to growth and collapse prior to repetition of this cycle.

Referring again to FIG. 6(a), to provide timed reflection of a compressive wave a perforated-type piston arrangement 641 and 642 can be used as shown at various locations in the arm regions. The perforated pistons permit stretching of the fluid in the chamber region while the chamber 610 is rotated, but the sudden burst of a pressure wave that is generated upon cavity growth and expulsion of the fluid into the arms can be reflected back to the chamber to permit cavity collapse after a set time which is dependent on the sound velocity and distance from the chamber, and also to push back the fluid being expelled. The space above the liquid in the two or more arms 611 and 612 could also be pressurized by pressure source 630 to the desired extent to permit improved collapse kinetics.

Benefits available from a centrifugal based fusion system can be significant. Unlike in the PZT driven systems where the bubble growth is usually in the Rₘ=1 mm range, the bubbles in such a centrifugal configuration can grow to a range of several cm (a 10 to 100 fold increase over PZT drives) due to the virtually continuous tension from the centrifugal force present as a consequence of chamber rotation. A ten to hundred-fold increase in Rₘ/Rₒ implies a potential factor of 10³ to 10⁶ increase in bubble volumetric growth and resultant implosion kinetics. Also, unlike PZT-driven systems, the rotating chamber can be driven by ordinary motor systems where the electrical-to-mechanical energy conversion efficiencies can be 90% or more. However, one potential disadvantage of centrifugal systems for certain applications is that centrifugal systems are generally limited to relatively low-frequency operation modes, such as up to 1 to 10 kHz.

Control of a centrifugal based system can be accomplished by the positioning of the reflectors (e.g. pistons), the degree of back-pressurization, the number of incident nucleating/trigger sources, the density of the fluid, the separation distance “r”, and the speed of rotation. Other parameters, such as the purity and gas content in the working fluid, will also generally play a role in system operation, as in the PZT-driven apparatus.

An alternate system 700 can use explosives or mechanically reciprocating devices to induce desired degrees of tensioned states followed by a compression stage to collapse bubbles. A pre-pressurized chamber 710 is unloaded explosively by firing a charge that permits a large rarefaction wave to travel into the liquid much like in a shock tube. In system 700, a reciprocating piston 720 produces mechanically generated rarefaction waves. The nucleation of cavities by application of energy from cavitation initiation source 730 takes place during the rarefaction stage. As with the PZT or centrifugal driven systems, bubble collapse takes place when compressive stresses lead the bubbles to implode.

The invention can be used for a variety of purposes. For example, the invention can be used for power (e.g. electricity) or heat energy generation, explosive burst generation, as a general purpose pulsed/continuous neutron or tritium generator, or a hybrid reactor combining the fission-fusion concepts. The scale of the system can be tailored for the specific application.

For example, for a relatively small-scale system the cavitation initiation source could be a dissolved emitter such as a uranium salt. A suitable drive system for such a system could be either a piezoelectric, magnetostrictive or mechanical system.

For large-scale power systems a reactor could be composed of several fuel assemblies either singly-or-separately driven to operate in resonance in or out of phase based on the descriptions provided in earlier sections.

Energy is generally required to begin the fusion process, such as to tension the working fluid and to produce bubbles from the tensioned fluid. For example, an external source of electricity or a battery source can be used to provide energy to initiate the fusion process. A battery or other energy storage device can be charged from energy generated from earlier operation of the fusion.

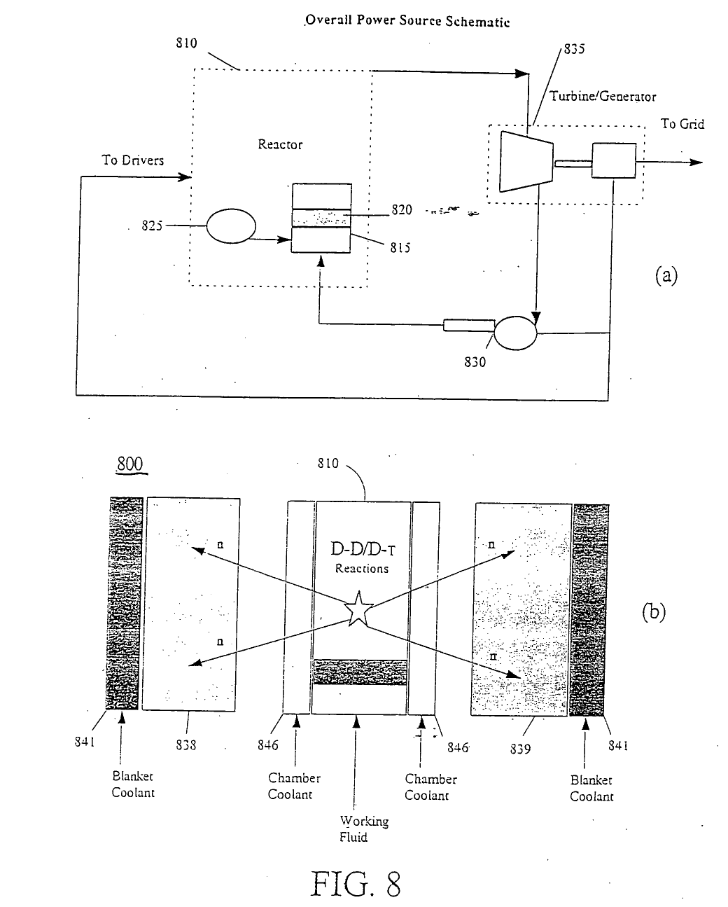

FIG. 8(a) is a schematic illustration of a fusion driven power system 800, while FIG. 8(b) is a schematic illustration of a fusion reactor including neutron blankets.

System 800 includes reactor 810. Reactor 810 comprises a reaction chamber 815 for holding the working fluid, a driver source 820 (e.g. PZT) for tensioning the working fluid and a cavitation initiation source 825 (e.g. PNG) for bubble nucleating bubbles from the tension working fluid. Pump 830 is provided for flowing the working fluid through reaction chamber 815.

System 800 generates fusion energy from bubble implosion triggered D-D or D-T reactions. These nuclear reactions emit neutrons which are carried to surrounding blankets, such as 838 and 839 shown in FIG. 8(b). As shown in FIG. 8(b), both reactor 810 and neutron blankets 838 and 839 may be provided structures for cooling, such as blanket cooling 841 for neutron blankets 838 and 839 and chamber coolant 846 for reactor 810.

Blanket and coolant material types are preferably materials such as lithium, which when interacted with neutrons produces tritium. Tritium can be then used as a fuel. Other blanket materials include molten metals or water that can moderate neutrons and absorb thermal energy that can be convected off.

Generally, it is expected that the fusion energy (generally mainly neutrons) produced by reactor 810 will be converted to electrical energy. In this embodiment, heat derived from neutrons produced by fusion reactions taking place in reactor 810 can be used to power turbine/generator 835. Turbine/generator 835 provides electricity to a grid (not shown) for distribution to a plurality of energy sinks. Once system 800 is operational, power for driver 820, such as a PZT, can be provided by turbine/generator 835.

However, heat generated by reactor 810 can be used for purposes other than generating electricity, such as to propel projectiles or to drive chemical reactions. For example, heat generated by the system can be used to produce hydrogen (H₂) for use as a fuel.

A method for converting fusion energy to electricity first collects the fusion energy which is largely in the form of fundamental particles, such as neutrons and gamma rays as heat. A suitable neutron blanket can be used to convert neutron energy generated from the fusion reaction to heat. The heat generated can be used to boil water, the boiled water driving a steam turbine. Alternative heat transfer fluids, such as liquid metal, or helium and alternate turbine drivers, such as helium can be used to improve efficiency as compared to steam based systems.

Fuel assemblies can utilize either stagnant or flowing liquids. Liquids are preferably degassed/purged and surrounded by a refrigerant system, such as a cold-air stream. The dimensions of the fuel assemblies are chosen based on the need to induce the appropriate level of fusion reactions and may be designed such that the emitted neutrons are minimally absorbed by the working fluid via absorption.

A neutron absorbing medium surrounds each assembly, such as blanket region including a heat exchange fluid. The blanket could also incorporate breeding materials such as Li to produce T for use as fuel similar to that done for Tokamak reactor concepts. The system could also utilize materials and related technologies recently publicized. The energy density from D-D and D-T reactions is quite large compared to chemical energy sources, such as TNT, as illustrated in Table 3 below.

TABLE 3
Comparison of fuel requirements for 1-kWh energy production

| Parameter | D-T fuel | D—D fuel | TNT |
|---|---|---|---|
| Mass (g) | 40 × 10⁻⁶ | 215 × 10⁻⁶ | 800 |
| Relative Ratio | 1 | 5 | 20 × 10⁶ |

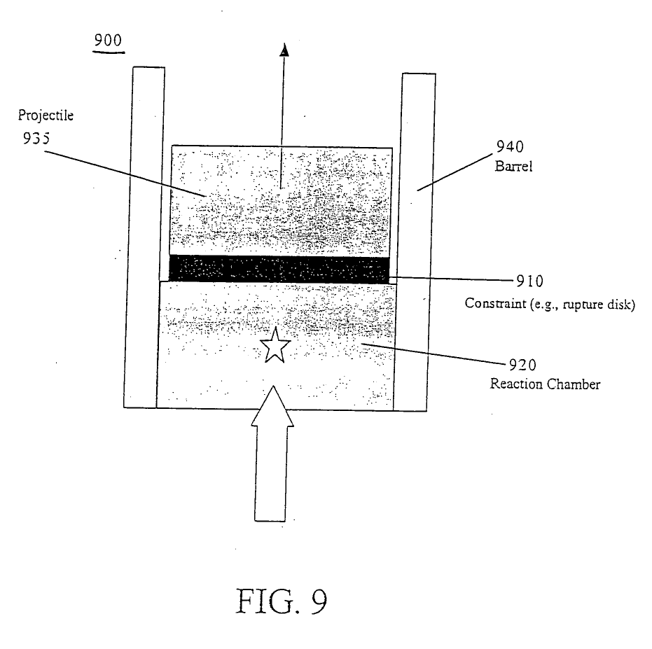

FIG. 9 depicts graphically how the fuel assembly system shown in FIG. 8(b) with slight modification could be employed to create controlled bursts of power for use as a burst generator. A burst generator can be used as a pulse power source, a propulsion source, an explosive or as a projectile launcher, such as projectile launcher 900 shown in FIG. 9. The modification includes an inertial constraint 910 which controls the buildup of heat and pressure in the reaction chamber 920 which is generated by dissipating neutrons in a suitable absorption medium, such as a neutron blanket (not shown). Upon release of the constraint, the released energy provides mechanical energy output to the desired system, such as to launch projectile 935 which is guided by barrel 940.

### EXAMPLES

### Example 1

### Experimental Setup

Acetone was used as the working liquid in experiments performed.

Non-deuterated acetone (C₃H₆O) was used as the control fluid and deuterated acetone (C₃D₆O) was used as the test fluid. Acetone was chosen because organic fluids, such as acetone, permit the attainment of large tensile states without premature cavitation. This allows high levels of liquid superheat to be built up prior to nucleation which leads to correspondingly higher implosion temperatures. Organic liquids are generally also desirable as working liquids because they generally have relatively large phase-change coefficients, which further enhances the attainable implosion temperature.

To minimize the effect of gas cushioning to promote rapid condensation during implosive collapse, highly degassed organic liquids were used. To degass the working liquid, the working liquid was subjected to an acoustic pressure field that oscillated in resonance with the liquid sample and its container. Alternatively, degassed liquids could have been provided.

Unless otherwise noted, the liquid in the chamber was maintained at about 0° C., which was the lowest value obtainable with the equipment available. Nucleation of vapor bubbles was initiated with fast neutrons from a pulsed neutron generator (PNG) that produces 14-MeV neutrons on demand at a predefined phase of the acoustic pressure field or from an isotopic neutron source (Pu—Be) including a shutter.

The system shown in FIG. 1 and further described in FIG. 2(a) was used for most experiments performed. The system included a Pyrex™ flask test chamber having a working fluid, a vacuum pump for degassing the test chamber, a generator coupled to a lead-zirconate-titanate (PZT) ring for generating acoustic waves for pretensioning the working fluid. The PZT driver ring was glued to the outer surface of the test chamber. The Pyrex™ flask measured about 65 mm OD and about 260 mm long (end to end, not counting the stem portions of the ends).

The PZT driver ring was excited by a linear amplifier (Piezo Systems, Inc., Cambridge, Mass. Part No. EPA-102-115). The amplifier and PZT driver ring provided about ±20 bar high frequency pressure fluctuations. If the experiments were performed with multi-PZT driver chambers without a base piston, the acoustic pressure fluctuations could have been up to about +/−50 bar.

A master waveform generator (WFG, Hewlett-Packard, Palo Alto, Calif., model 33120A, with 2-ppm stability) was connected to an amplifier and then to the PZT ring. The master WFG was also phase-locked to an identical slave WFG to introduce a phase shift in trigger pulse signals transmitted to the 14-MeV PNG.

Either a plastic scintillator (PS) or a liquid scintillation (LS) detector was used for detection of neutron and gamma signals. A Bicron BC404 PS, Newberry, Ohio, having dimensions of 5 cm by 2.5 cm was in a light-tight enclosure and used along with a Elscint LS (Elscint Limited, Haifa, Israel) having dimensions of 5 cm by 5 cm. Two pill microphones were attached and disposed on opposite sides of the test chamber to record noise signatures from imploding bubbles.

Emitted light was detected and amplified in a photomultiplier tube (PMT), backed by a charge-sensitive preamplifier (ORTEC model 264, ORTEC Products, Oak Ridge, Tenn.) PMT bias was supplied by a Tennelec Model TC951 high-voltage power supply, Tennelec Inc, Oak Ridge, Tenn. The PMT was biased with a high-voltage power supply manufactured by Stanford Research Systems, Inc., Sunnyvale, Calif. model PS325.

The PS was positioned as shown to provide a time marker for neutron pulse generation and also for recording possible nuclear emissions during bubble implosion and in between PNG pulses. A 2-ns rise time Hamamatsu R212 PMT and a Hamamatsu C1053-51 5 MHz bandwidth preamplifier, (Hamamatsu, Ichino, Japan) were used to record SL light flash emission.

A two-channel 500-MHz digital storage oscilloscope (Hewlett-Packard model 54616B) was used to capture and record SL flash and PS signals. A four-channel 100-MHz digital storage oscilloscope (Hewlett-Packard model 54645A) was used to capture and record microphone output, voltage to the PZTs, and the trigger pulses to the PNG.

A liquid scintillator (LS) detector-based system was set up for pulse-shape discrimination (PSD). The PSD circuit separates neutrons from gamma rays on the basis of differences in the PSD scintillator signal decay time between neutrons and gamma rays. The system could be operated to permit blocking of gamma rays (hereafter, a mode of operation referred to as “with PSD”). The net efficiency for fast neutron detection was estimated to be about 5×10⁻³.

In the experimental sequence of events (FIGS. 3(a)-(f)), neutrons from the PNG nucleate vapor bubbles in the tensioned working liquid by exceeding the cavitation threshold of the working liquid at the time of the neutron burst (FIG. 3(a)). The nuclear radiation detector typically detected a pulse when the PNG was fired (FIG. 3(b)). Thereafter, the vapor bubbles grew until increasing pressure in the liquid during the second half of the acoustic cycle caused them to begin to collapse (FIG. 3(c)). If the implosion was robust enough, the bubble emitted an SL light flash, which was detected by the PMT (FIG. 3(d)).

If the working liquid includes deuterium (D) and/or tritium (T) atoms, and the temperature is sufficient to induce D-D or D-T fusion, nuclear particles, such as neutrons and gamma rays will be emitted and can be detected at either the plastic scintillator (PS) or LS detector. Moreover, in cavitation experiments, when a bubble implodes, a pressure wave (shock wave) that travels at about the speed of sound in the test liquid is also generated and can be detected at the chamber walls by suitable microphones.

### Example 2

### System Dynamics

An important parameter concerns the timing and occurrence of the 14 MeV neutron pulse produced by the fusion reaction relative to the cavitation initiation source pulse. With a system configured using a PNG cavitation initiation source and the electronic timing systems described above (FIG. 1), it was found by analyzing the time spectrum of PNG emitted neutrons that neutrons were emitted over a time span of about 12 s (4 to 6 μs at full width at half maximum (FWHM)). Neutron counts were reduced considerably after about 15 to 20 μs following the PNG firing. The PNG bursts were timed to be initiated when the working liquid tension state was greatest, such as at 270° after the positive zero crossing of the sound pressure field in the center of the test chamber.

For multiple-bubble implosions, several bubbles can implode and emit closely spaced SL flashes during any given cycle.

The time between a SL flash and the shock wave signals received at two microphones set up on diametrically opposite sides of the test chamber was found to be about 27 μs. This is in good agreement with the time for a shock wave to travel from the center of the chamber to the glass wall located about 32 mm away. This result indicates that the bubbles are generally nucleated and imploded in or around the central axis of the test chamber. The frequency of bubble-burst generation varied from about 15 to 35 or more bursts per second, depending on the state of tuning.

The efficiency of SL flash detection was dependent on the PMT bias voltage which determines the gain and the chosen discriminator settings. SL detection with the PMT (a Hammamatsu R212 with 2-ns rise time) varied strongly with bias voltage. At −300V, about one SL flash every 10 s was detected, whereas about 1 to 5 SL flashes/s were detected at a −450 V bias.

Data was obtained using a PZT drive amplitude much greater than that required for threshold nucleation. Because of this, and because the PNG pulse width was about 4 to 6 μs (FWHM), nucleation could occur a few microseconds before or after the minimum liquid pressure was reached.

The timing of the SL flash relative to the PS pulse was analyzed with a multichannel analyzer (MCA). The PZT drive frequency was about 19.3 kHz, which corresponds to a full cycle time of about 52 μs. The time spectrum of events confirmed that the PS flash corresponding to the PNG activation lasting about 12 μs, with 4 to 6 μs FWHM was followed by a SL flash lasting about 4 to 6 μs FWHM, about 27 to 30 μs later.

### Example 3

### Tensioning N-Acetone (C₃H₆O) and D-Acetone (C₃D₆O)

Experiments were conducted with C₃H₆O (100% nominally pure) and C₃D₆O (certified 99.92 atom % D-acetone) obtained from W.M. Barr & Co., Memphis, Term. The working liquids were filtered before use through 1 μm filters. Degassing was performed by applying a pressure of about 10 kPa and acoustically cavitating the liquid for about 2 hours.

To ensure continued robust nucleation growth and implosive collapse, the drive voltage to the PZT was set to be about double that needed for occasional cavitation, which is defined herein as the occurrence of nucleation and collapse within a 10-s observation period. The negative pressure threshold for bubble nucleation by neutrons and alpha particles in acetone is known to be approximately −7 to −8 bar.

A pressure map of the test chamber was obtained using a calibrated hydrophone. Using the scale factor for induced pressures in the test chamber versus drive voltage to the PZTs, and gradually increasing the drive amplitude, it was determined that the cavitation began at about −7 bar, which is consistent with the known value. The pressure amplitude in the test chamber was about ±15 bar, which equates to about ±220 pounds per square inch.

### Example 4

### Tritium (T) Detection, Monitoring, and Estimation

As noted earlier, one of the two possible D-D fusion reaction outcomes produces T and protons. Therefore, in addition to the evidence collected for neutron or gamma ray activity, detection of the formation of T provides additional evidence regarding the occurrence of bubble induced D-D fusion.

To measure T activity, the working fluid was sampled directly with a scintillation counter calibrated for detecting T. A Beckman LS6500 scintillation counter, calibrated to detect 5 to 18 keV beta ray decays from tritium, was used for this purpose. Unless otherwise noted, T detection experiments used 14-MeV neutrons generated at a rate of about 10⁶ neutrons/s from the PNG spread over the specified time duration.

Testing of C₃H₆O and C₃D₆O was performed with tensioning and PNG irradiation and with PNG irradiation alone (without tensioning; referred to as without cavitation) using same experimental configuration, including placing the chamber under standard vacuum conditions of about 10 kPa. In this way, the experiments were conducted systematically, changing only one parameter at a time.

The chamber was initially filled with C₃H₆O and irradiated for 7 hours without cavitation. A 1-cm³ liquid sample was withdrawn from fluid in the top region in the acoustic chamber and mixed with Ecolite and tested for T activity. Thereafter, cavitation experiments were performed for 7 hours. A 1-cm³ sample of C₃H₆O was again withdrawn and tested for T activity. This same process was later repeated for 12 hours.

After verifying the absence of T activity from the control tests which did not include tensioning with C₃H₆O, the experiments were repeated with C₃D₆O. The irradiation and cavitation experiments of 7 hours duration with C₃H₆O and C₃D₆O were repeated several times at about 0° C. A separate test was conducted over 5 hours, using a Pu—Be neutron source producing about 10⁶ neutrons, to assess the influence of randomly produced neutrons.

Tests were also conducted to assess the impact of liquid temperature on T activity buildup by testing with C₃D₆O at about 22° C. (room temperature). Finally, to assess the impact of the time of irradiation and cavitation on T buildup in C₃D₆O, testing was also conducted for 12 hours with PNG irradiation of about 106 neutrons/s at about 0° C.

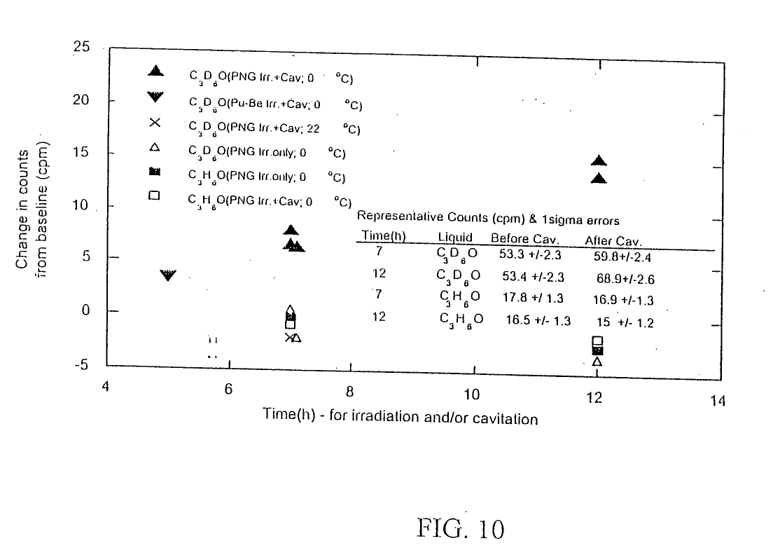

Results of these experiments are summarized in FIG. 10, which includes values of standard deviation as well as background count rates. The data reveals no significant change in T activity for C₃H₆O with or without cavitation and neutron irradiation. Under the same experimental conditions, irradiation alone of C₃D₆O samples with 14-MeV neutrons, or with neutrons from a Pu—Be source, did not result in any statistically significant change in T content. In contrast, in three separate 7-hour cavitation experiments with C₃D₆O which provided −15 bar tensioning of the working liquid at about 0° C. and 10⁶ neutrons/s irradiation with the PNG, an average increase of 7.1 T counts per minute (cpm) resulted.

Similarly, two separate 12-hour experiments produced an average increase of 14.6 cpm, the increase being directly proportional, within statistical counting errors, to the increase in duration of the test. Overall, cavitation of C₃D₆O at about 0° C. with 106 neutron/s PNG irradiation over 7 hours resulted in T increases of up to about 8.1 cpm (representing an individual difference of about 2.5 standard deviations (SD) and a collective change of about 4 SD), whereas cavitation and irradiation over 12 hours resulted in an average increase of about 14 cpm, representing an individual difference of more than 4.5 SD.

Finally, cavitation of C₃D₆O at about 22° C. with 10⁶ neutrons/s PNG irradiation over 7 hours did not result in any significant change in T activity.

As will be described later, this agrees with the lack of SL activity at this higher temperature and is also consistent with hydrodynamic shock code simulations performed.

Assuming none of the T produced reacted with D atoms, an inverse calculation based on the observed T activity indicated that the D-D neutron production rate was about 7×10⁵ neutrons/s.

### Example 5

### Neutron Energy Spectra Data Acquisition with PSD

The PSD described above was used in experiments with and without cavitation to check for neutron production and to determine the energy range in which significant increases in neutron counts occurred. Tests were conducted with the PSD system so that only neutron counts were accepted by the data acquisition system. For identical settings, it was verified that the PNG neutron output varied by about ±0.2% from measurement to measurement. Tests, with a PNG neutron output of about 10⁶ neutrons/s, were conducted with C₃H₆O (as the control fluid) and with C₃D₆O for data acquisition times from 100 to 300 s, during which neutron counts were accumulated at the rate of about 500 counts/s.

Changes in counts under the no cavitation condition were evaluated in two energy ranges. The first covered the range between the lowest energy detectable and 2.5 MeV. The second was from 2.5 MeV upward.

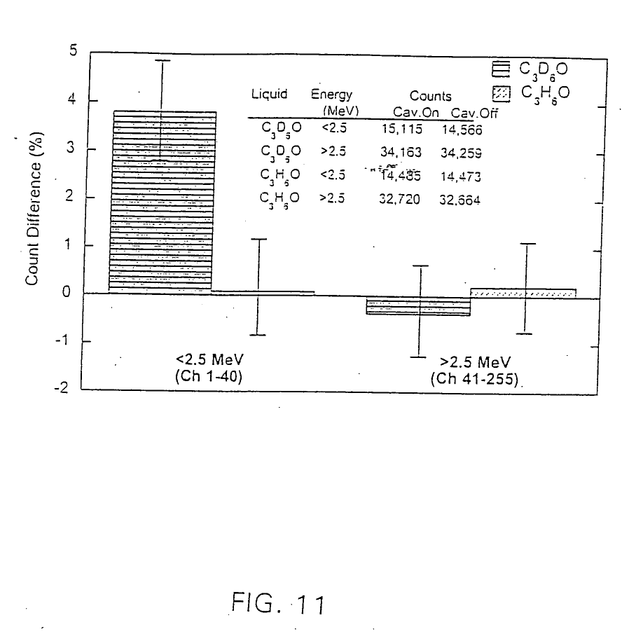

Representative results for the sample with C₃D₆O evidencing an increase in counts and the background counts are shown in FIG. 11 for observations over 100 s in the two energy ranges. As shown, 4% increase in 2.5-MeV neutrons was shown in the C₃D₆O samples after the onset of cavitation. The variation in neutron counts for the control liquid (C₃H₆O) was within about 0.2% in both energy ranges. The data were repeatable for 300 second acquisition times.

Assuming Poisson statistics, 1 SD from a total population count varying from 50,000 to 150,000 ranges from about 0.4 to 0.25%. Therefore, a 4% change in counts for a case with cavitation is a significant increase of 4 SD above background. Because the data were repeatable, when taken as an aggregate, the average 4% increase in counts represents a statistically significant change of at least 10 SD above background. For a 4% increase in the case of C₃D₆O with cavitation in the 2.5-MeV range, and using a distance-corrected detector efficiency about 1 to 2×10⁻⁴, the D-D neutron emission rate associated with cavitation was estimated to be 4×10⁴ to 8×10⁴ neutrons/s. This value is somewhat smaller than the estimated rate of neutron generation from the tritium measurements (about 7×10⁵ neutrons/s). At least part of this difference can be attributed to uncertainties in detector efficiency, such as neutron energy losses by scattering in the test chamber or reduced detection efficiency for large-angle knock-ons from 2.5 MeV neutrons.

### Example 6

### Coincidence Data Acquisition

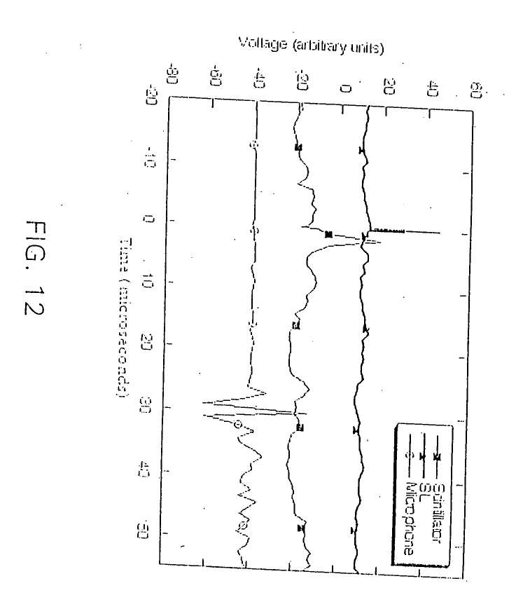

The degree of coincidence between the SL and PS/LS pulses was also examined. Coincidence spectra were obtained by direct visual observations and manual recording of the individual coincidence signals on a digital storage oscilloscope triggered by the SL signal. Two different data acquisition modes were tested. For mode 1 operation, at a low bias voltage for the PMT, it was conclusively determined that no false SL activity occurred during PNG operation, and that coincidence between SL and scintillator signals repeatedly took place for cavitated C₃D₆O at about 0° C., but not for the C₃H₆O control liquid. An example of data traces for cavitation tests with C₃D₆O showing coincidence between the SL flash and the scintillator pulse, and the subsequent microphone response about 30 μs later is shown in FIG. 12.

No such SL and PS/LS pulse coincidence, followed by a microphone trace, was seen for tests with the control liquid C₃H₆O, with or without cavitation. However, data acquisition with this mode of operation was slow, because many genuine SL signals were rejected as well.

In the second mode of operation (mode 2), the bias voltage to the PMT was increased to −450 V, resulting in some spurious SL signals generated during PNG operation. However, this effect was accommodated for by taking data with and without cavitation, leaving all other parameters the same, and then subtracting the coincidence data taken without cavitation from those taken with cavitation. The PNG was operated at about 10⁶ neutrons/s at 200 Hz.

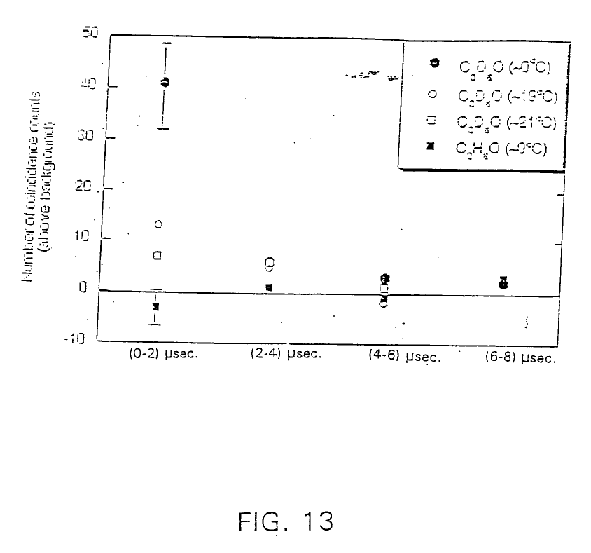

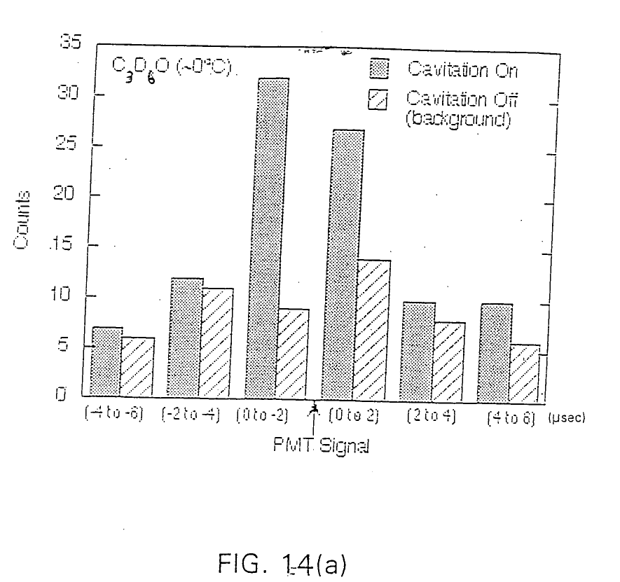

FIG. 13 shows typical coincidence data spectra taken in mode 2 operation with C₃H₆O and C₃D₆O. C₃D₆O at 0° C. produced high levels of coincident counts as compared to either C₃H₆O at 0° C. or C₃D₆O at 19° C. and 21° C.

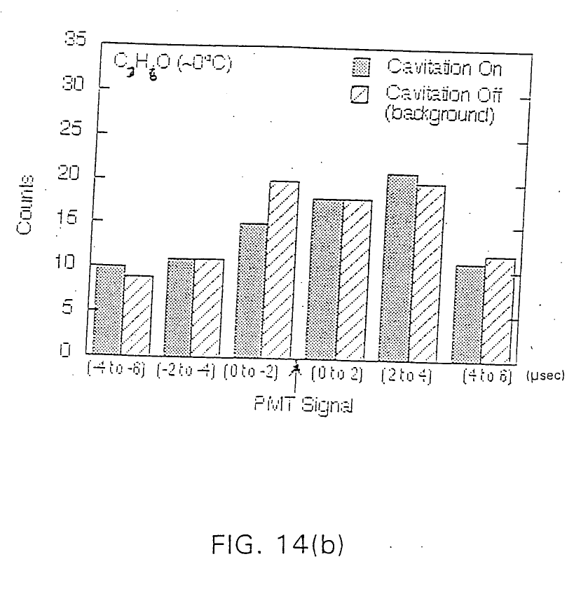

FIGS. 14(a) and 14(b) show measured coincidence counts for cavitation and background counts (cavitation off) with PNG operation for C₃D₆O and C₃H₆O at 0° C., respectively. Counts taken without cavitation, that is, those that occur during PNG operation which are all random or false, were subtracted from counts taken with cavitation over the same recording interval. Data gathered in this mode were binned in 2-μs bins before and after the PMT signal. The experiments were repeated several times, with similar results.

Only for tests performed with C₃D₆O with cavitation at 0° C. did a sharp peak in net coincidences occur in the 0 to 2 μs interval on either side of the PMT (SL) signal, after which the coincidence events tapered off to within 1 SD. No such peaking of coincidences was seen for the control fluid (C₃H₆O) at 0° C., nor did the cavitation on data differ from the cavitation off data for the C₃H₆O control.

It is useful to compare data for C₃D₆O obtained at about 19° C. and about 21° C. (FIG. 13) versus data for C₃D₆O obtained at about 0° C. (FIG. 14(a)). At the higher working liquid temperature of about 20° C. there was more evaporation and less condensation as compared to 0° C. As a result, the bubble collapse was less intense, and the number of coincidences was sharply reduced.

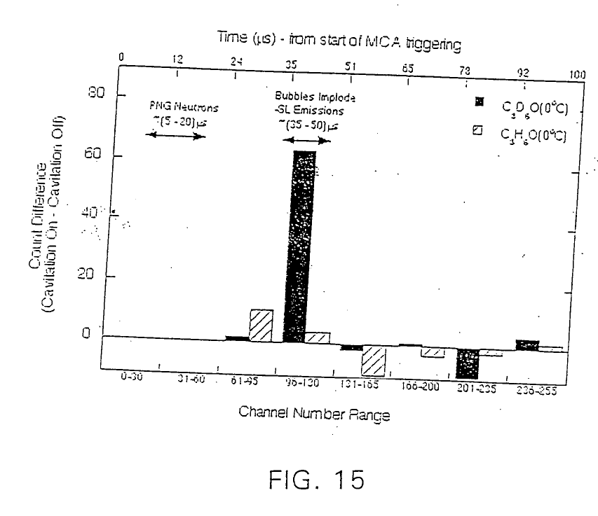

FIG. 15 shows results obtained with C₃D₆O and C₃H₆O at about 0° C. using MCA time spectrum data. FIG. 15 again shows PS or LS signals evidencing detection of penetrating nuclear radiation were coincident with the PMT signals detecting SL light emission during bubble implosion for C₃D₆O. Coincidence was not seen in the control tests with C₃H₆O.

Measurement of 2.5-MeV neutrons in this environment is difficult due to the background of 14-MeV pulsed neutrons and associated gammas from the PNG. Independent attempts to reproduce the neutron data using a different detection system and electronics yielded smaller neutron emission. Additional analysis was conducted that demonstrated compatibility between the two sets of observations.

### Example 7

### Analysis of Bubble Implosion Using Simulations

To obtain an estimate of the implosive collapse conditions and to help understand the observed experimental data trends, a one-dimensional hydrodynamic shock (HYDRO) code was developed to numerically evaluate the conservation equations of each phase during bubble growth and collapse. This code includes the Mie-Gruniesen equations of state and Born-Mayer potential functions, which are known to be valid for highly compressed fluids.

In particular, for acetone, these equations of state are based on the shock wave adiabat data of R. F. Trunin et al., Khimiche Skaya Fizika, vol. 11, 424 1992 (in Russian), which implicitly specify the effect of the induced radiation field and the dissociation and ionization processes that take place during plasma formation within imploding bubbles. Moreover, relevant energy losses and the effect of both molecular and electron/ion conductivity were taken into account, and the resultant HYDRO code allowed for the evaluation of shock wave interaction using the well-established Godunov numerical technique.

Bubble dynamics were studied in C₃D₆O for conditions typical of those used in experiments performed. It was found that highly compressed conditions suitable for thermonuclear fusion were predicted, and, as can be seen in FIG. 16, the results were sensitive to the values of the phase change (accommodation) coefficient, α and the liquid pool temperature Tₒ. There is a strong sensitivity to Tₒ because at low temperatures there is less evaporation and more condensation of the vapor during bubble expansion and compression, respectively, which in turn reduces the cushioning effect of the compressed vapor during implosions.

Similarly, larger values of α yield more condensation and thus more intense vapor compression. C₃D₆O has an α value of approximately 1.0, while D₂O has a relatively low value of a (0.075). In addition, water tends to cavitate prematurely before reaching reasonably high pressures, a problem not generally experienced by acetone. Thus, C₃D₆O appears to be a better working fluid as compared to heavy water.

To obtain an estimate of the D-D fusion neutron production rate, fusion neutron kinetics equations and fusion cross sections can be evaluated over a range of uncertain parameters to arrive at reasonable estimates for the neutron production rate, varying from about 10⁻² to 10 neutrons per implosion. Direct photographic evidence of the bubble cluster suggests that there were about 1000 bubbles in each bubble cluster in the experiments performed. Since up to 50 implosions/s were observed during the experiments performed, the HYDRO code predictions yielded neutron production rates ranging from about 10³ to 10⁶ neutrons/s, which is qualitatively consistent with the estimates from the tritium production rate, and the fusion neutrons measured in the experiments performed.

Many modeling assumptions were necessarily made in the HYDRO code, such as the equations of state, the use of an effective temperature to approximate the behavior of the electrons and ions in the plasma, and the relevant energy losses, and various mechanisms for shock wave intensification. In particular, a roughly tenfold increase in the external driving pressure was used in the calculations, to account appropriately for the effect of pressure intensification within the imploding bubble clusters. Thus, predicted trends and basic physical phenomena that have been modeled agree with the experimental observations recorded.

Experimental and Simulation Summary

Observations that statistically significant tritium activity increases only in chilled (0° C.) cavitated C₃D₆O, coupled with evidence for neutron emissions in chilled cavitated C₃D₆O, as compared to the absence of neutron emissions and tritium production in control tests with C₃H₆O provide strong evidence for cavitation induced nuclear fusion. The experimental data is complemented by confirmatory modeling and HYDRO code simulations, further evidencing D-D fusion during acoustic cavitation experiments with C₃D₆O.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

1. A nuclear fusion reactor, comprising:
a) a reactor chamber for holding working liquid molecules, said working liquid molecules including at least two nuclei of heavy isotopes of hydrogen;
b) structure for placing at least a portion of said working liquid into a tension state, said tension state being below a cavitation threshold of said liquid, said tension state imparting stored energy into said liquid portion;
c) a nuclear cavitation initiation source for nucleation of at least one bubble from said tensioned liquid, said bubble having as an nucleated bubble radius being greater than a critical bubble radius of said liquid;
d) a pressure field source for growing said as nucleated bubble to form at least one expanded bubble; and
e) a pressure field for imploding said expanded bubble, wherein following implosion of said expanded bubble a resulting temperature sufficient to induce at least one nuclear fusion reaction is provided to said liquid.

2. The reactor of claim 1, further comprising a vacuum pump for degassing said liquid.

3. The reactor of claim 1, wherein said structure for placing said liquid under tension comprises an acoustical wave source.

4. The reactor of claim 2, wherein said acoustical wave source includes an acoustical wave focusing device.

5. The reactor of claim 1, wherein said structure for placing said liquid under tension comprises at least one centrifugal source.

6. The reactor of claim 1, wherein said structure for placing said liquid under tension comprises at least one magnetostrictive source.

7. The reactor of claim 1, wherein said structure for placing said liquid under tension comprises at least one piezoelectric source.

8. The reactor of claim 1, wherein said as nucleated bubble radius is less than 100 nm.

9. The reactor of claim 1, wherein a ratio of a maximum radius of said expanded bubbles divided by said as nucleated bubble radius is at least 10⁵.

10. The reactor of claim 1, wherein said nuclear source comprises at least one selected from the group consisting of alpha emitters, neutron sources and fission fragment sources.

11. The reactor of claim 1, wherein said nuclear source comprises a neutron source.

12. The reactor of claim 11, wherein said neutron source is an isotopic source having at least one shutter, said shutter opened to synchronize neutron impact with a location in said liquid when said liquid is at a predetermined liquid tension level.

13. The reactor of claim 1, wherein said nuclear source comprises an alpha particle source.

14. The reactor of claim 13, wherein said alpha particle source is dissolved in said liquid.

15. The reactor of claim 1, wherein said liquid comprises deuterated acetone.

16. The reactor of claim 1, wherein said reactor further includes a controller for synchronizing delivery of at least one cavitation initiation signal from said cavitation initiation source at a predetermined location in said liquid.

17. The reactor of claim 1, further comprising a structure for cooling said liquid to a temperature below an ambient temperature.

18. The reactor of claim 1, wherein said fusion reaction generates at least one of tritium and neutrons.

19. The reactor of claim 1, further comprising at least one external constraint for restraining said liquid.

20. A nuclear fusion-based electrical power plant, comprising:
a) a reactor chamber for holding working liquid molecules, said working liquid molecules including at least two nuclei of heavy isotopes of hydrogen;
b) structure for placing at least a portion of said working liquid into a tension state, said tension state being below a cavitation threshold of said liquid, said tension state imparting stored energy into said liquid portion;
c) a nuclear cavitation initiation source for nucleation of at least one bubble from said tensioned liquid, said bubble having an as nucleated bubble radius being greater than a critical bubble radius of said liquid;
d) a pressure field source for growing said as nucleated bubble to form at least one expanded bubble;
e) a pressure field for imploding said expanded bubble, wherein following implosion of said expanded bubble a resulting temperature sufficient to induce at least one nuclear fusion reaction is provided to said liquid; and
f) structure for converting energy released from said fusion reaction to electrical energy.

21. A nuclear fusion-based projectile launcher, comprising:
a) a reactor chamber for holding working liquid molecules, said working liquid molecules including at least two nuclei of heavy isotopes of hydrogen;
b) structure for placing at least a portion of said working liquid into a tension state, said tension state being below a cavitation threshold of said liquid, said tension state imparting stored energy into said liquid portion;
c) a nuclear cavitation initiation source for nucleation of at least one bubble from said tensioned liquid, said bubble having an as nucleated bubble radius being greater than a critical bubble radius of said liquid;
d) a pressure field source for growing said as nucleated bubble to form at least one expanded bubble;
e) a pressure field for imploding said expanded bubble, wherein following implosion of said expanded bubble a resulting temperature sufficient to induce at least one nuclear fusion reaction is provided to said liquid; and
f) a movable constraint bounding said reaction chamber for transferring energy from said fusion reaction to propel a projectile.

22. A method for producing nuclear fusion, comprising the steps of:
a) placing working liquid molecules into a tension state, said working liquid molecules including at least two nuclei of heavy isotopes of hydrogen, said tension state being below the cavitation threshold of said working liquid, said tension state imparting stored energy into said working liquid;
b) cavitating at least a portion of said tensioned liquid with nuclear particles sufficient to bubble nucleate at least one bubble, said bubble having an as nucleated bubble radius greater than a critical bubble radius of said liquid;
c) growing said as nucleated bubble to form at least one expanded bubble using a pressure field; and
d) imploding said expanded bubble, wherein a resulting temperature from said implosion is sufficient to induce a nuclear fusion reaction involving said liquid.

23. The method of claim 22, wherein said fusion reaction is a D-D reaction or a D-T reaction.

24. The method of claim 22, further comprising the step of degassing said liquid.

25. The method of claim 22, further comprising the step of cooling said liquid to a temperature below an ambient temperature.

26. The method of claim 22, wherein a centrifugal source is used for said tensioning.

27. The method of claim 22, wherein an acoustical wave source is used for said tensioning.

28. The method of claim 27, further comprising the step of focusing acoustical waves provided by said acoustical wave source.

29. The method of claim 22, wherein said as nucleated bubble radius is less than 100 nm.

30. The method of claim 22, wherein a ratio of a maximum radius of said expanded bubbles divided by said as nucleated bubble radius is at least 10⁵.

31. The method of claim 22, wherein a neutron source is used for generating neutrons, further comprising the step of synchronizing neutron impact with a location in said working liquid having a predetermined liquid tension level.

32. The method of claim 22, further comprising the step of synchronizing delivery of at least one cavitation initiation signal with a desired tension level in said liquid.

33. The method of claim 23, wherein said liquid comprises deuterated acetone.
